(19) United States
(12) Patent Application Publication
(10) Pub. No.: US 2010/0138272 A1
(43) Pub. Date: Jun. 3, 2010

(54) SYSTEM AND METHOD FOR DETERMINING A THRESHOLD OF DECOMPOSITION FOR ENABLING INCREMENTAL DEVELOPMENT OF PERSISTENT AND REUSABLE BUSINESS COMPONENTS AND CONTROL STRUCTURES IN AN ASSET BASED COMPONENT BUSINESS MODEL ARCHITECTURE

(76) Inventor: Guy Jonathan James Rackham, New York, NY (US)

Correspondence Address: Whitham, Curtis, Christofferson & Cook, P.C., Suite 340, 11491 Sunset Hills Road, Reston, VA, 20190, US

(21) Appl. No.: 12/325,288

(22) Filed: Dec. 1, 2008

(51) Int. Cl. G06Q 10/00

(52) U.S. Cl. 705/10; 705/7

(57) ABSTRACT

A method and system for generating a business architecture by decomposing an asset based model of the business to a threshold level of decomposition, at which level the decomposition resolves into elemental design elements having asset types which are commercialized by corresponding elemental control structures. At this level of decomposition the elemental design elements and their elemental control structures are reusable in other businesses. This decomposition technique may be applied incrementally to gradually displace legacy systems in the course of developing an asset based architecture for the business.

### RELATED APPLICATIONS

This invention is related to the following contemporaneously filed patent applications, the disclosures for each of which, including drawings, are hereby included by reference: application Ser. No. 12/______ (IBM Docket No. END920070273US1) for “SYSTEM AND METHOD FOR ESTABLISHING A COMMERCIAL ECOSYSTEMS BLUEPRINT IN AN ASSET BASED COMPONENT BUSINESS MODEL ARCHITECTURE”; application Ser. No. 12/______ (IBM Docket No. END920070274US1) for “SYSTEM AND METHOD FOR ASSEMBLY OF BUSINESS SYSTEMS FROM REUSABLE BUSINESS CONTROL ELEMENTS IN AN ASSET BASED COMPONENT BUSINESS MODEL ARCHITECTURE”; application Ser. No. 12/______ (IBM Docket No. END920070275US1) for “SYSTEM AND METHOD FOR STRUCTURED COLLABORATION USING REUSABLE BUSINESS COMPONENTS AND CONTROL STRUCTURES IN AN ASSET BASED COMPONENT BUSINESS MODEL ARCHITECTURE”.

### BACKGROUND OF THE INVENTION

1. Field of the Invention

The present invention generally relates to business architecture, and in particular to systems and methods for organizing a business to adapt quickly to changing conditions.

2. Background Description

In describing the shortfalls in current approaches to business architecture an analogy to building architecture may be used. Buildings are tangible items with distinct physical properties whereas a commercial business is a more complicated entity, combining many tangible elements such as offices, factories and equipment with intangible elements such as product designs, market knowledge and customer goodwill. Even so much can be inferred about the nature of business architecture by comparing it to the well established ‘art and science’ of buildings.

The following table compares some aspects of building architecture with their business architecture equivalent:

TABLE 1

| Architectural | | |
|---|---|---|
| Element | Building Architecture | Business Architecture |
| Vision | Artist's | the Business Model |
| | impression/vertical | |
| | elevation | |
| Requirements | Building's purpose/use | Business strategy and |
| | | plans |
| Rules | Planning regulations | Regulatory environment |
| Specifications | Building material | Technology, organization |
| & standards | specifications | and procedural standards |
| | | and guidelines |
| Blueprints | Many including: Site | Many including: |
| | plan, building plan, | organization charts, office |
| | plumbing diagram, wiring | layout, operational |
| | diagram, interior design | procedures, systems/IT |
| | specification | plans |
| Tooling | CAD/CAM drafting tools | Business design tools |

Some rows in the table include building architecture content that can be easily related to well established and equivalent approaches that would fit a corresponding business architecture. For example the building architect's “vision” maps to a commercial enterprise's business model, “requirements” define the supporting business strategy and plans. Similarly “rules” and “specifications” can be related to various commercial standards and guidelines that regulators, trade associations and markets in general might impose. The key row in the table to compare in more detail is the use of different types of “blueprints” or model representations.

The role of a model is both to simplify the representation and then highlight or accentuate some specific aspect of its subject. For example in building architecture a wiring diagram would typically include a very simple schematic of the room layout but would then add extensive detail relating to the specification and routing of the electric wiring and electronic components.

In order to fully define some entity represented by an architecture such as a building a wide range of different models are used. To determine what models might be needed one could list all the parties that would be involved in the ‘art and science of designing and making a building’ and then select model views that would help define their associated facet of the architecture. Easy to identify are the model views that might be needed by the builders, glaziers, plumbers, electricians, decorators, and furnishers.

Then there are the less obvious perspectives of the building owners and inhabitants—buildings and their architectures are more than the physical elements, they are built with a use in mind—a room might be intended as a dining room or a lecture hall, a building might be a police station or a shopping center. Model views of ‘uses’ are harder to visualize but, with respect to a building, designs specifying a type of room and/or simple descriptions usually suffice. This association between a room and its intended use is essential to complete the overall building architecture as the finer details of the construction will be defined by the intended uses made of different rooms.

As a wiring blueprint can overlay the routing of the wiring and positioning of electronic components within the rooms of a building design, an information technology (IT) overlay can be developed showing the information flows and processing within the business components of a business design. IT solution design is one aspect of business design in the same way that electrical wiring is one specialist aspect of building design. IT design for business is clearly more complex than its electrical wiring counterpart as it deals with information rather than the simple commodity of electric power.

The example of the architecture of a building and the role of a wiring blueprint within that architecture is used to highlight the important design decision that determines what aspects of the interactions between components (and internal component operation) are suited to an IT based solution and what best remains an aspect of person to person communications. The prior art approach to this design decision is to focus on the automation role of IT, and apply automation IT to the internal execution of a business building block, and also to the collaborative functions of certain building blocks (e.g. production in manufacturing) where the interactions with other building blocks are structured and sequential or involve structured data. With respect to building blocks in the business control domain, where message traffic is conversational and the nature of interactions with other building blocks is largely asynchronous, the prior art design choice leaves the solution of business control problems to person to person communication.

Business architecture needs to include model views to address considerations analogous to the different blueprints in a building architecture for electrical wiring, plumbing, heating and the like; however, this is where existing approaches fall short. Though there is no shortage of different model representations of commercial business there are major problems associated with combining these model views into an integrated design that compares to building architecture:

Few models for intangible ingredients—unlike building design where the constituent ingredients are mostly tangible items, a significant proportion of business design involves intangible ingredients such as reputation, knowledge, and customer relations for which effective and practical model representations are scarce.

Usage is often only informally linked to ingredients—the fairly simple association of usage with a room in building architecture is not so easily handled in commercial activity. Usage views or process models are probably the dominant type of model used in business design. But the definition of the links between the steps in a process and the underlying commercial assets/ingredients that are employed are not always formal nor are they comprehensive, particularly with respect to intangible assets.

Model inconsistency—in a building architecture most model views are easily related to the general room layout of the building and hence to each other. There is no equivalent ‘layout’ of commercial business to help align models to an integrated business architecture.

Furthermore, the inconsistency of models currently being applied to business architecture conceals a more fundamental problem. While businesses grow and change, it is disruptive to the business when changes demanded by the market place make too many of its architectural models obsolete. Business requires a certain level of stability in its models; business cannot operate efficiently in the market place if too large a portion of the systems developed from these models have to be replaced when the business adapts to changed market conditions.

Given these shortfalls in prior art approaches to business architecture it is not surprising that the ‘big picture’ view and easy navigation between various specialist perspectives supported in the conventional architecture of physical buildings is not readily available to the architecture of a business. As a result, business design often ends up as a disparate collection of models, each attuned to a specific feature but without any assurance that a change in market conditions will not make many of them obsolete and without a coordinating framework to bring them together into an integrated whole that has reasonable prospects for enough stability over time that the business can concentrate its resources on serving the market place profitably, without draining resources into renewing computer supported business models that have become obsolete.

Developing approaches to business designs that yield computer support structures that are more resilient in response to changes in market conditions and more adaptable to changes in the structure of the commercial ecosystem continues to be an elusive goal. There is a need for improved methodologies in this area.

### SUMMARY OF THE INVENTION

An aspect of the invention is a method and system for developing an asset based business architecture by decomposition to a threshold level. The decomposition can be accomplished incrementally by a series of steps, each step being directed to assets and corresponding commercialization mechanisms associated with adapting the business to a particular market change. In the incremental approach, one or more elemental design elements encompass the assets and corresponding commercialization mechanisms associated with the particular adaptation. Each of these elemental design element—at the threshold of decomposition—is characterized by a stable and persistent commercial role, that is, a role that persists over time and is generic across businesses and industries. The elemental design element is defined by an asset type of the business and an elemental control structure for commercializing the asset type to produce a value for the business. If the correct threshold level has been reached in the decomposition, it should be the case that each decomposed asset type and corresponding elemental control structure has one and only one parent, and at least one child element at the next level of decomposition has two separate elemental design elements as parents.

The threshold level of decomposition is confirmed by comparing the decomposed asset type and corresponding elemental control structure with a corresponding elemental design element from a component business model (CBM) map of an industry within which the business competes.

In another aspect of the invention each elemental design element at the threshold level is provided with information systems support for operation of the corresponding elemental control structure. In the incremental approach, the elemental design elements associated with a particular market change are configured as a collaborative network, each elemental design element being supported by a suitably configured information system. An un-configured, but configurable, template for the information system should be located on the industry CBM map. In a further aspect of the invention, the information systems supporting the respective elemental design elements, by combination in the collaborative network, displace a legacy information system. Typically, the legacy information system is a process based system encompassing a number of business components with a set of procedures that are relatively inflexible.

The nature of the present invention is to use elemental business control structures, as defined hereafter, to model and align solutions to more flexible patterns of behavior. This allows the business designer to define the context and participants in business activity, as opposed to defining a prescribed sequence of steps in a process that might be automated.

The present invention uses a business design technique that isolates business components that both map to the building blocks of an asynchronous, collaborative operating model as well as establishing a unifying concept that can provide the foundation for business architecture. But there is a further implication of this design approach that has far reaching implications for the nature of solutions that are developed conforming to these designs with respect to operational re-use.

The design technique employed by the present invention is asset based rather than process based. It derives commercialization mechanisms and associated control structures needed to exploit/leverage different types of commercial assets. For the specification of the control mechanisms it distinguishes between the purpose or role which is relatively constant over time and its particular implementation that does evolve as new practices are discovered or invented.

Asset types are not specific to any one industry. Items such as staff, buildings, equipment, knowledge, customer relationships occur in many if not all industries. Similarly, the commercialization mechanisms associated with the use of an asset type are themselves fairly generic. For example, for asset type ‘customer relationship’ and the associated commercialization mechanism ‘account for payments/receipts’ is a general requirement.

Industry specific requirements (and other reasons for specialization such as geopolitical, scale or sophistication) are related to specific features of the implementation of the commercialization mechanism rather than its purpose or role. Business designs are typically preceded by an analysis that decomposes the business, beginning with the highest conceptual level that defines the purpose of the enterprise and continuing down to a detailed implementation level.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A is a schematic representation showing traditional techniques for improving a business process.

FIG. 1B is a schematic representation of a plurality of processes supporting a business.

FIGS. 1C and 1D are schematic representations of an early and late stage, respectively, in the incremental displacement of a business process based architecture with an architecture of stabilized CBM components operating as a service network.

FIGS. 2A, 2B and 2C are schematic representations, respectively, of a building architecture, an asset based business architecture, and a process based business architecture.

FIG. 3 is a schematic representation of a collaborative network in the film industry; FIG. 3A is a table of indicia for transformation to a collaborative network; FIG. 3B is a schematic representation of different operating properties of the two domains of business control and production; FIG. 3C is a schematic representation of a business model innovation having an expanded role for business control with reference to production.

FIGS. 4A and 4B are charts showing stages of market ecosystem evolution under an architecture using an asset based model.

FIG. 5A is a diagram showing a layered hierarchy of designs to support commercialization of assets.

FIG. 5B is a schematic showing CBM control mechanisms applied to exploiting the asset type “customer”.

FIGS. 5C and 5D show a business control lattice and its enhancement, respectively.

FIG. 5E is a schematic diagram showing the structural elements of a service center component.

FIGS. 6A and 6B are schematic diagrams showing hierarchical structures where the levels in the structure are related by single inheritance and multiple inheritance, respectively.

FIG. 7 is a schematic diagram showing a hierarchy having a threshold level below which a single inheritance decomposition degenerates into a multiple inheritance decomposition.

### DETAILED DESCRIPTION OF A PREFERRED EMBODIMENT OF THE INVENTION

The inventor of the present invention also invented the co-pending invention described in U.S. patent application Ser. No. 11/176,371 for “SYSTEM AND METHOD FOR ALIGNMENT OF AN ENTERPRISE TO A COMPONENT BUSINESS MODEL” (hereinafter termed “the above referenced foundation patent application”), whose disclosure is hereby incorporated by reference as foundational for the present invention in content and terminology.

The present invention uses a business design methodology that stipulates that commercial business activity can be modeled by first identifying a general collection of asset types, some combination of which is brought together to form an enterprise. The combination of asset types ‘owned’ or somehow made available to a business are each then manipulated in one or more generic ways in the execution of business, using structures referred to as ‘commercialization mechanisms’, that is, mechanisms through which an asset is made commercially useful to the enterprise in terms that can be measured financially. Examples of general asset types are employees, production capacity, buildings and facilities, intellectual property. Corresponding examples of commercialization mechanisms are: for employees (contract, assignment, payroll, certification/qualification), for production capacity (production schedules, production configuration), for buildings and facilities (office allocation, facilities allocation schedules, operating schedules, maintenance schedules), for intellectual property (patents, licenses, assignments, deployments). Under this business design methodology computer systems are used to implement instances of one or more of these commercialization mechanisms.

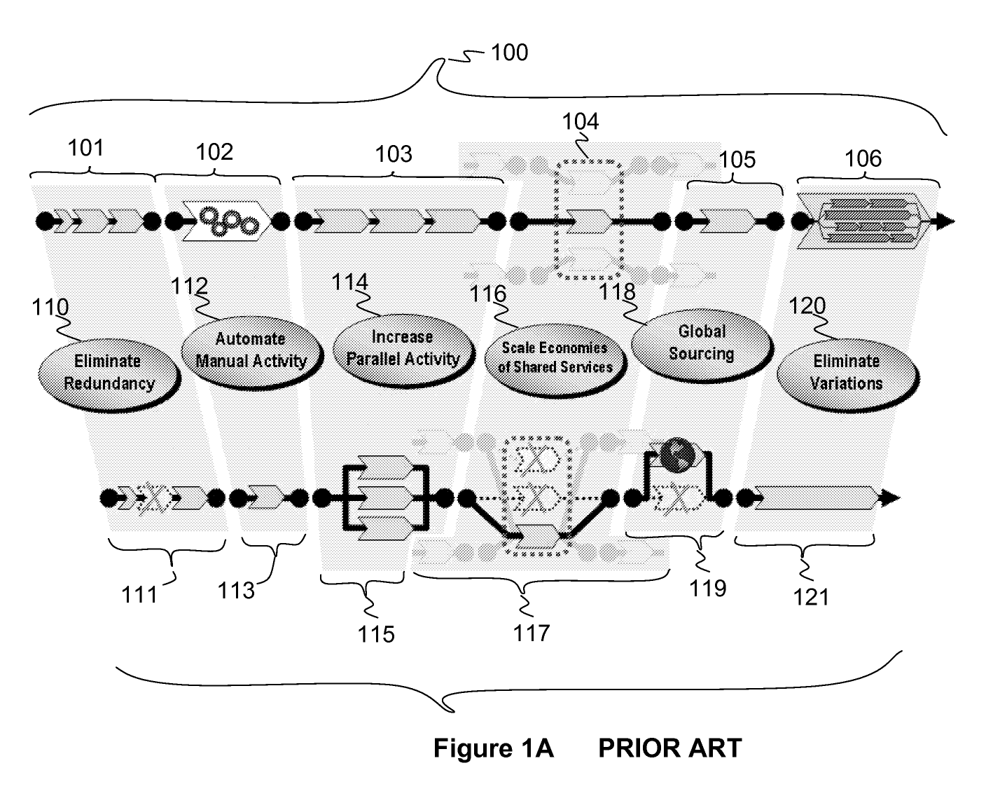

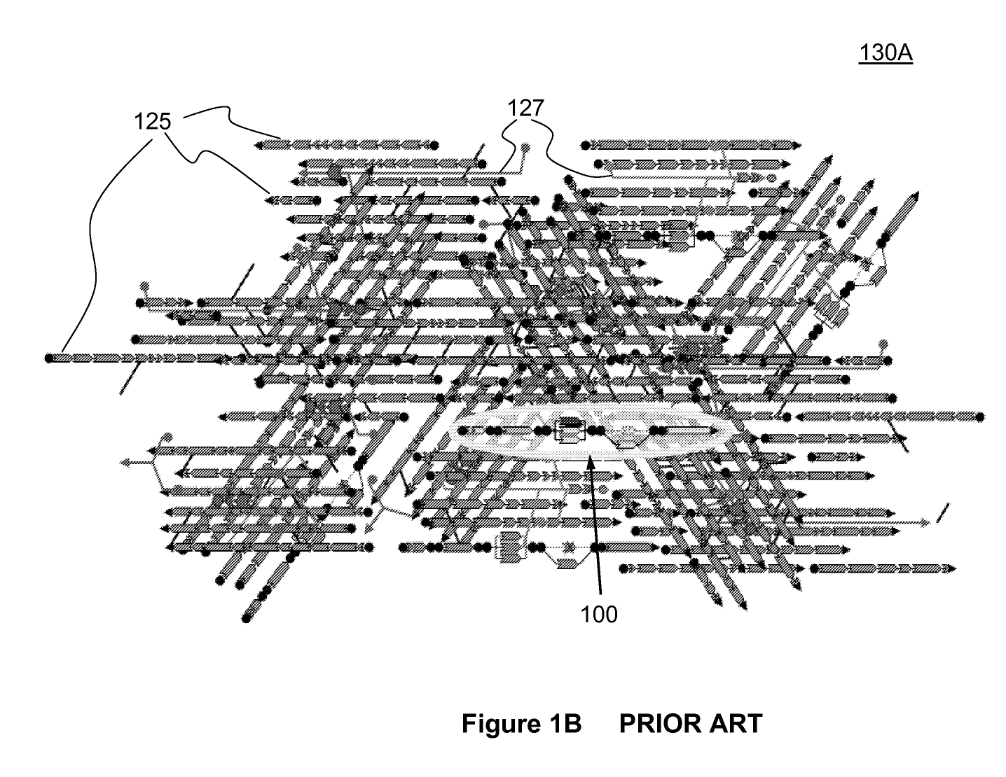

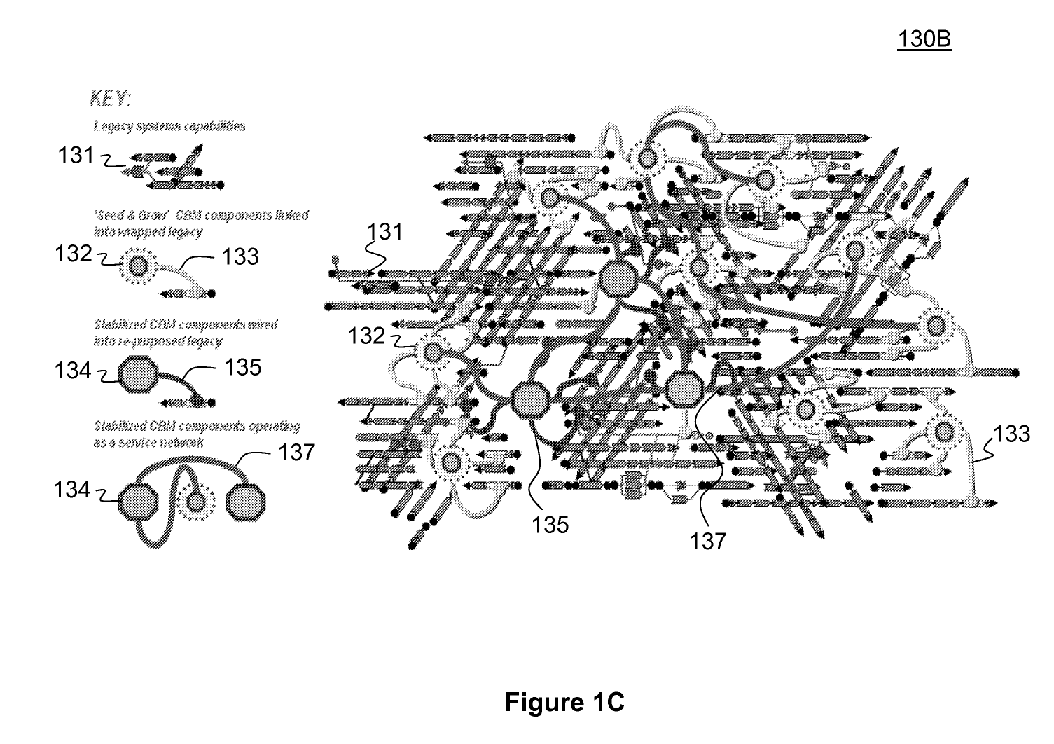

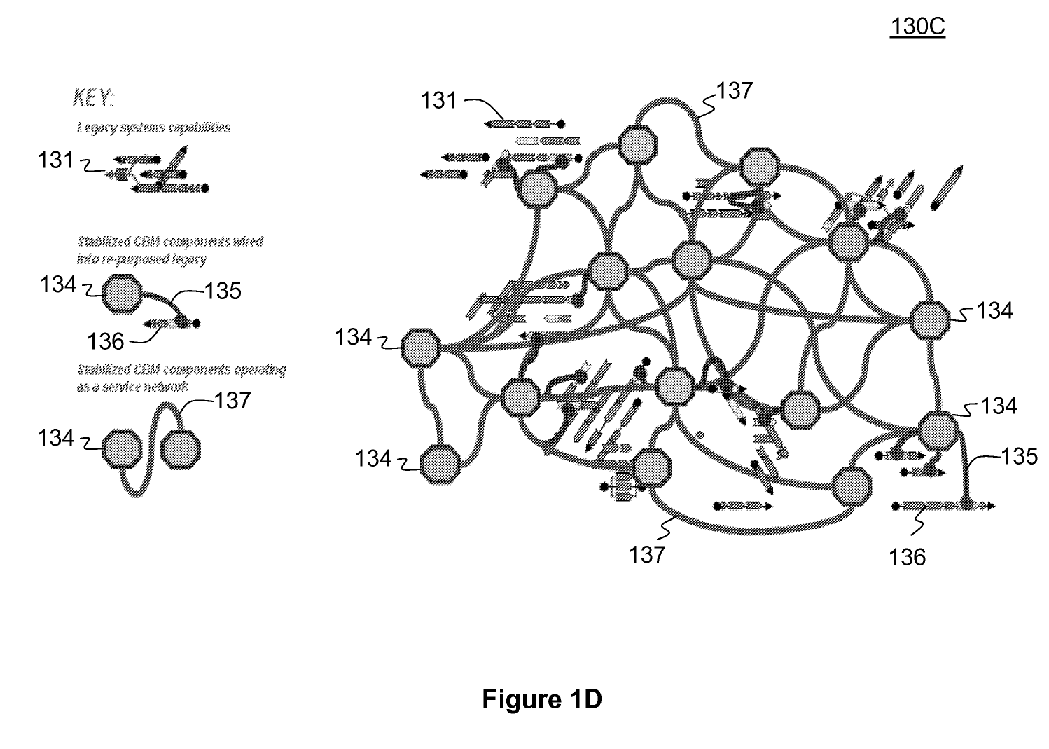

Conventional business design is dominated by process analysis. That is, the focus of analysis is a sequence of activities performed by the business to achieve an outcome of net value. As shown in FIG. 1A traditional process improvement for a business process 100 focuses on six general techniques. First, the process 100 is analyzed to identify 101 and eliminate redundancy 110, as represented by 111. Second, manual activity (represented by 102) is automated 112, as represented by 113. Third, where possible, activities that had been performed in sequence (represented by 103) are performed in parallel 114, as represented by 115. Fourth, scale economies are invoked to combine separately performed services 104 under a common service that is shared 116, as represented by 117. Fifth, sourcing (represented by 105) is expanded to include global sources 118, as represented by 119. Sixth, an effort is made to standardize multiple ways of doing a process (represented by 106) by eliminating variations 120, as represented by 121.

As those skilled in the art will appreciate, a business process is in fact performed with the resources available to the enterprise. These processes are often modeled by computers, and supported by computer implemented systems having various interfaces with the other resources used to perform the various processes through which the business operates. The process 100, described in FIG. 1A, is therefore a more general representation of a business process that may be modeled and supported by a computer implemented system. Process 100 is shown in FIG. 1B in context with other processes (e.g. processes 125), which may interconnections (e.g. as represented by 127). A typical large business may have several hundred significant business processes that represent behaviors that traverse different aspects of the organization in a complex matrix of overlapping and interacting processes, as represented by 130A. The design technique upon which the invention relies allows these processes 125 and their interconnections 127 to be gradually replaced with substantially fewer asset based component structures, as will now be shown with reference to FIGS. 1C and 1D.

It is to be noted (as is more fully explained in the above referenced foundation patent application) that asset based components are logical structures and do not necessarily correspond to physical organizational structures of the enterprise. And, as with processes (e.g. 100, 125), the work performed by these components is, in fact, performed by the resources of the enterprise. However, components in this implementation are non-overlapping aggregations of activities defined with reference to assets of the enterprise, the work being represented as services. Each component may be both a user and a provider of services.

Initially, these asset based component structures 132 are linked 133 into wrapped legacy processes 131. As these component “seeds” 132 grow within matrix 130B of business processes they become stabilized components 134, that is, they more fully implement the supporting structures (as hereinafter described) characteristic of the design techniques upon which the present invention is based. Corresponding to this growth phase, related legacy processes are re-purposed to more explicitly account for the component. Thus the connection 135 between the stabilized component 134 and the re-purposed legacy process 136 is more formally integrated into the operation of the business. As this growth continues, more stabilized components 134 are developed, operating together as a service network (represented by links 137). Eventually, this service network of asset based components substantially displaces the matrix of business process structures, as shown in the progression from 130B to 130C. In this scenario, remaining legacy processes 131 continue operation until displaced by the service network of stabilized CBM components.

The design concept employed by the present invention is asset based rather than process based, as indicated above, and has features and aspects that result in solutions that are both highly re-useable (i.e. the same solution can be deployed in different commercial organizations with minimal rework) and that can be adopted incrementally (i.e. the specific capability can work alongside existing facilities and added to over time as might best benefit the commercial business).

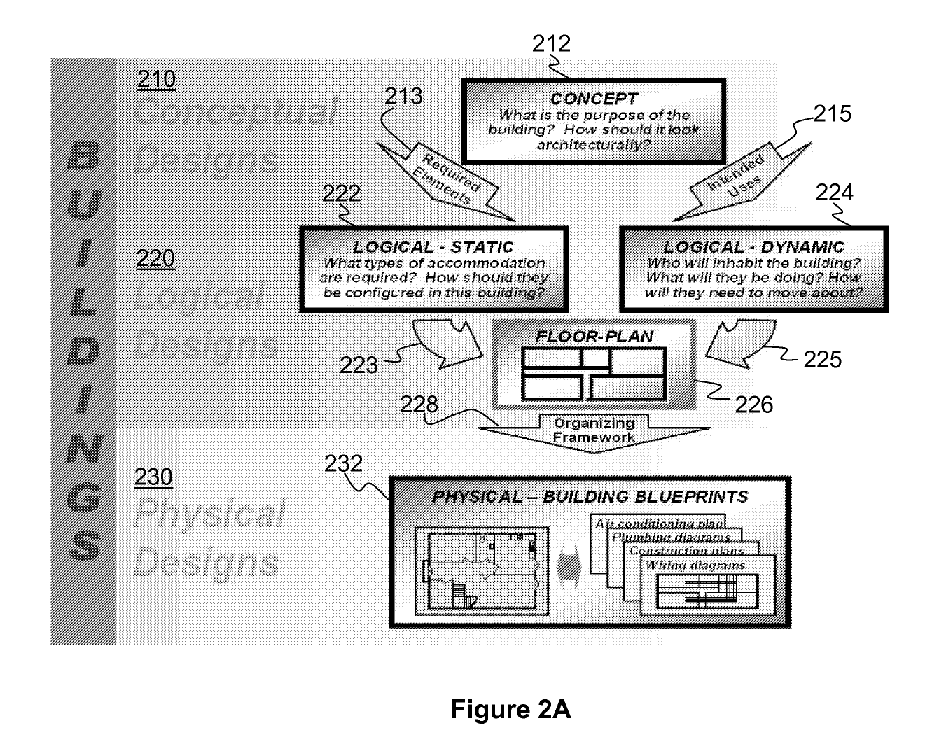

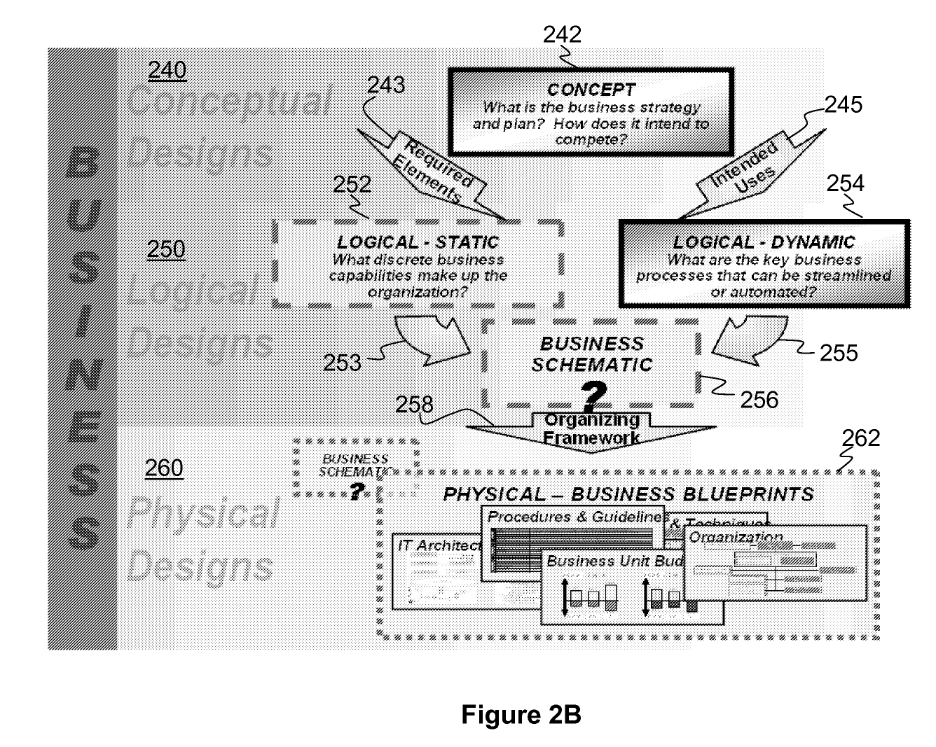

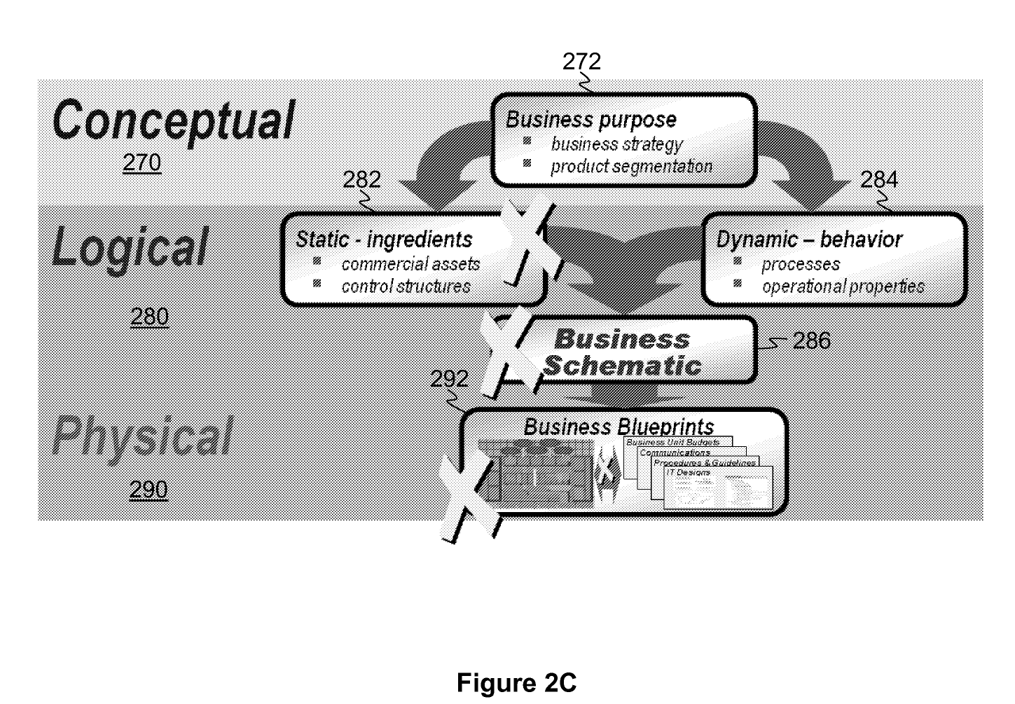

The design concept derives in part from properties observed in mature architectural approaches such as building design as are then interpreted in the less mature field of business architecture. “Architecture” in the generic sense may be defined as the art and science of designing and building a solution. One implementation of this generic view of architecture recognizes three layers of design with some key properties to the design representation at each layer, as will now be described with reference to FIGS. 2A, 2B and 2C.

At a conceptual level, a design defines the external perspective of the entity, stating its purpose and high level properties, without going into any detail of how it might be realized in practice. For building architecture 210 this would be the purpose of the building such as a school, and then any associated properties that might help specify its need/justification/role. How should the building look from an architectural point of view? For Business Architecture (BA) the equivalent 240 is the mission or purpose and market strategy of the organization. How does the business intend to compete?

At a logical level (e.g. 220, 250), a design defines the structure of the entity by combining two perspectives into a consolidated view. The first perspective defines the ‘static’ aspects of the entity, in other terms the ingredients or persistent elements that collectively make up the entity. The second perspective defines the ‘dynamic’ aspects of the entity, in other terms the behaviors that the entity wishes to undertake and/or support. By combining sufficient detail of static and dynamic perspectives, a consolidated logical view of the entity can be developed, that selects and configures sufficient ingredients in combinations/layout as needed to enable the desired behaviors for the entity. This consolidated logical view defines an organizing ‘blueprint’ for the lower level physical design.

For building architecture, the static logical designs 222 refer to concepts such as types of accommodation (a kitchen, a dining room, a meeting room) for which, in terms of static design properties, there may be standard features and/or best practices and guidelines for their specification. These static designs 222 make use of ingredients or elements 213 which are appropriate for the building purposes 212. These static designs 222 are responsive to questions (and corresponding answers or determinations) about the types of accommodations that are required and how they should be configured in this building. The dynamic designs 224 for building architecture relate to intended uses 215 of the building, e.g. entertaining, group discussion, isolated working. These dynamic designs 224 are responsive to questions and corresponding determinations about who will inhabit the building, what they will be doing, and how they will need to move about.

For business architecture the static 252 and dynamic 254 perspectives relate well to the concepts exposed using the design principles upon which the present invention is based. Required elements 243 for a static design 252 would be a combination of an asset type and an associated control mechanism. These elements within the component business model imply a capability or use which is relatively persistent, and therefore the corresponding designs 252 are relatively static. For example, the asset type “employee” in combination with the “assignment” control mechanism implies a specific capability or use, namely, staff being assigned. Assigning employees to tasks is a capability that has been used in the past and will continue to be needed in the future. Thus the capability is persistent and the logical designs 252 that invoke this capability are relatively stable and, therefore, static.

On the other hand, while the capability is persistent and static, an instance of this capability may be invoked in a dynamic pattern, such as staffing up a new project. Furthermore, the precise mechanisms employed to invoke this capability may well evolve as decision making processes become more sophisticated. Moreover—and of particular significance to operation of the present invention—the stability provided by these asset based capabilities enable significant efficiencies in responding to the needs of the business to adapt in a competitive environment.

These adaptations in a competitive environment remain driven by the business purpose 242. As shown in FIG. 2B, intended behaviors 245 of the assets 243 are implemented through dynamic designs 254 which define operational behavior using models (e.g. process and collaborative models). A business architected in alignment with the Component Business Model (CBM) together with the enhanced CBM structures of the present invention will still need the functionality provided under prior art process oriented architectures. However, this functionality is more simply and more stably provided because of reliance upon persistent asset based component structures coupled with appropriate mechanisms for the commercialization of those assets. The dynamic designs 254 are responsive to questions (and corresponding answers or determinations) about what are the key business processes that can be streamlined or automated. These questions will also be asked in prior art process oriented business architectures, but the development of responsive answers under the prior art will not be able to rely upon the relatively stable logical designs 252 of the present invention, as further described in connection with FIG. 2C.

Thus an important aspect of the design approach upon which the present invention is based is that the intended behaviors 245 are enabled by commercialization mechanisms addressed to the assets 243 which are the ingredients required for the static designs 252. These mechanisms are the means by which the assets 243 required by the business purpose 242 provide commercial value to the enterprise. The output from dynamic logical designs 254 is selection and configuration 255 of static elements 253 (i.e. assets coupled with commercialization mechanisms) needed to support the identified dynamic behavior. Consequently, the logical designs 250 are at the intersection of static and dynamic behavioral analysis.

This results in a business schematic 256 that provides a coherent and specific structure, analogous to the floor plan of a building, around which particular “blueprints” for operating the business may be integrated. An important advantage provided by the invention is that the streamlining or automation of key business processes is more efficiently accomplished by selection and configuration 255 (using dynamic design 254) of relatively persistent contents 253 of the assets and commercialization mechanisms enabled by static design 252.

At the level of physical design (e.g. 230, 260) the implementation of architecture defines various aspects of the logical design. In building architecture these implementations 232 might be the primary structure, the décor, the wiring and plumbing. The floor-plan 226 serves as a consolidating organizing framework 228 for integration of the configuration decisions 225 provided by the dynamic design 224 with content 223 made available through static design 222. The logical design 220 plays a critical role in physical design 230 by defining a representation of the entity that is shared by all implementing physical designs 232. The floor-plan function 226 is operable because as an organizing framework it supports and structures an integration of the content 223 from the static designs 222 with the configuration 225 requirements driven by the dynamic designs 224. The physical designs 232 possess the item design properties determined by the static designs 222, and the building blueprints 232 conform to the design outline determined by the dynamic designs 224. The logical design 220 coordinated through a common floor-plan 226 ensures that the different physical representations refer to a consistent subject and can be implemented in a manner by which they all integrate. This approach maintains referential integrity between the different representations of a single coherent entity. That is, all building blueprints 232 consistently reference the same subject of the design from their different perspectives.

In building architecture the consolidating organizing framework 228 is provided by the floor plan 226, and as long as the different physical designs relate consistently to this consolidated logical blueprint, a coherent physical realization of the entity can be assembled. That is, for example, the wiring and plumbing will line up to the walls and decor of the intended room layout.

In business architecture the equivalent logical organizing framework is provided by the business schematic 256, which is the layout resulting from the arrangement and configuration of the asset types and their commercialization mechanisms. The combination of an asset type and a commercialization mechanism in the business architecture envisioned by the invention, as identified by static logical design 252, is analogous to a “room type” or an “accommodation type” in building architecture. The number and configuration of these ingredient “types” required for a particular business environment is determined as necessary to support the dynamic behaviors identified in the dynamic logical design 254.

It is important to recognize the consequence of this business architecture upon the CBM structure described in the above referenced foundation patent application. As a building might need three bedrooms, a business might need multiple realizations of a particular component. These multiple realizations may be viewed as three dimensions of “cardinality” of a business component. First, a component might repeat between lines of business within the enterprise. Second, a component might repeat between different geo-political environments within which the enterprise operates. Third, a component might vary when realized in different physical environments. For example, a customer interaction component may be implemented as a call center in one physical environment but as a web-site in another physical environment. Further, the customer interaction component may be supported for different products of the business and may be run in different regions of the world.

Thus the layout represented by business schematic 256 is an integration of the content 253 structured by the static designs 252 with configuration requirements 255 driven by the dynamic designs 254. In the design approach which is the premise of the present invention, the foundation for this layout is the component business map of the enterprise. Each component within this map represents a non-overlapping cluster of activities, each cluster corresponding to a logical and not necessarily physical view of the enterprise, so that the components on the map are mutually exclusive and collectively exhaustive in their coverage of the enterprise. Thus the component provides a distinct locus for the realization of one specific commercialization mechanism applied to one specific asset type. It is this combination of an asset type and a commercialization mechanism within a component that is the logical “atom” of content 253 that is configured 255 into business schematic 256. Thus the components may be viewed as being structured around asset types and the services provided by the component may be understood as being dependent upon the commercialization mechanisms. Furthermore—as an extension of the distinction between the logical character of components and the physical structures of the enterprise—a component may have multiple instances within the physical structures of the enterprise, of the kinds described above, responsive via configuration requirements 255 to an analysis of the desired dynamic behaviors determined in dynamic design 254.

However, it should be emphasized that business schematic 256 represents a well defined mapping to physical structures of the enterprise. The component business map itself represents a distillation of the activities of the enterprise to form a logical mapping from the enterprise. As described in the above referenced foundation patent application, this logical mapping may identify needed changes in the activities of the business (and, consequently, in terms of the present invention, changes in assets and commercialization mechanisms) in order to align the enterprise with the component business model of the enterprise. A significant value of the analysis that distills the activities of the enterprise into a component business map is that it provides a view of the enterprise—a mapping, if you will—that clarifies differences between where the enterprise is targeted to be and where it is, actually, in relation to the targeted service oriented structures.

The premise of the present invention is a further transformation, in the reverse direction, from the component business map back to the physical structures of the enterprise. The physical designs 262 possess the unit design properties 253 determined by the static designs 252. The physical designs 262—“business blueprints”—also embody the configuration decisions 255 determined by the dynamic designs 254. In this way the physical designs 262 reverse the distillation represented by the component business map itself, because these “business blueprints” translate directly into a fully configured and structurally complete enterprise, an enterprise architecture that conforms to business schematic 256. Thus the reverse transformation, in accordance with the conceptual designs 240, logical designs 250 and physical designs 260 which are foundational for the present invention, results in a set of business blueprints 262 that are coordinated through a common business schematic 256. In other words, the business schematic 256 serves as an organizing framework 258 for the business blueprints that map to the physical structures (i.e. assets commercialization mechanisms) through which the activities of the enterprise are conducted. It is the configured business schematic 256 that is analogous to the “floor plan” in a building architecture and through which different implementations or physical designs 262 of the entity—such as its organization charts, its financial plans, and its resource allocations—are coordinated.

As will now be noted with reference to FIG. 2C, a process oriented design approach does not provide the overall coherence of a ‘blueprint’. At the conceptual design level 270 a process design approach reflects the same business purpose 272. However, at the logical design level 280 there is no place in the design of business processes for a static view 282 of commercial assets and their corresponding control structures. The design of business processes is heavily focused on dynamic behavior 284. These “dynamic” views of key behaviors are not mapped to any representation if the “static” business ingredients. To use an analogy to building architecture, it is like describing how the residents might want to prepare and eat a meal without being able to describe the role of the kitchen and dining room in that behavior. The process approach enables optimization of the recipe and approach to preparing the meal, but does not accommodate in a coherent and integrated way the context within which the meals are prepared.

In the same way a business process approach articulates the dynamic aspect of business behavior but is unable to fully define the context within which the behavior is executed, or more precisely define the capabilities that are involved in its execution. As a consequence there is no business schematic 286 having the relative stability provided by static ingredients 282, and without the business schematic 286 there is no basis for coordinating subordinate business blueprints 292 at the physical level 290.

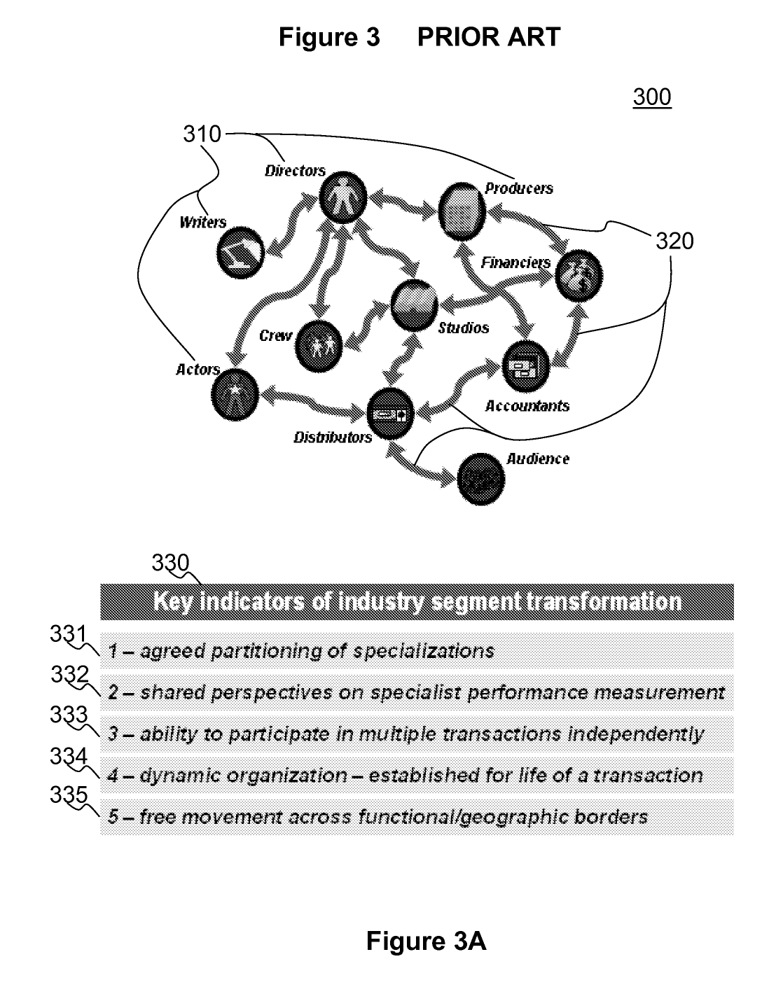

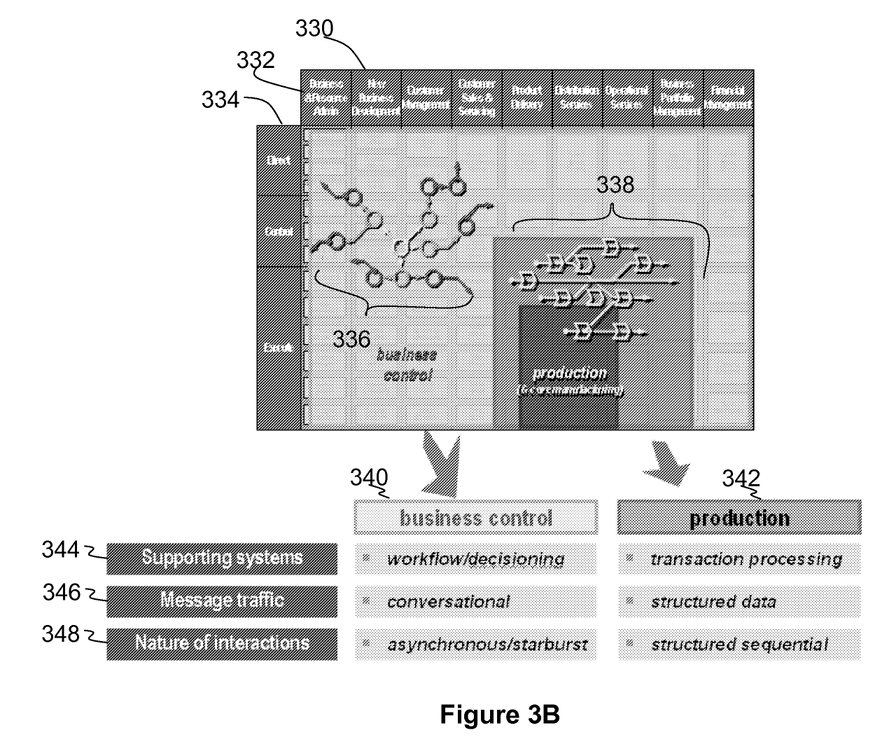

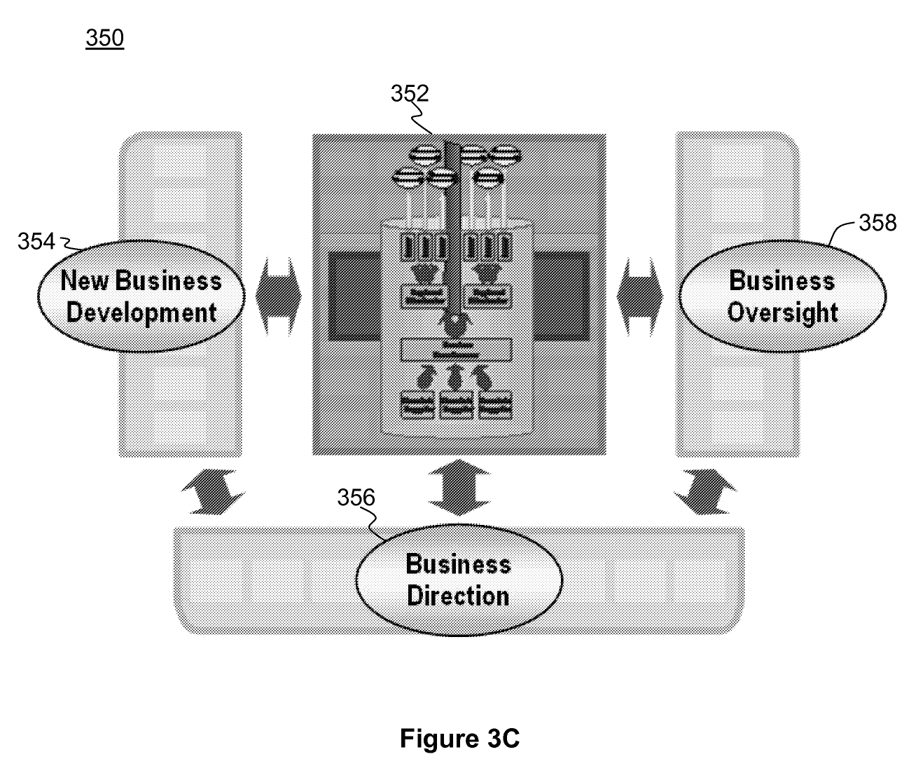

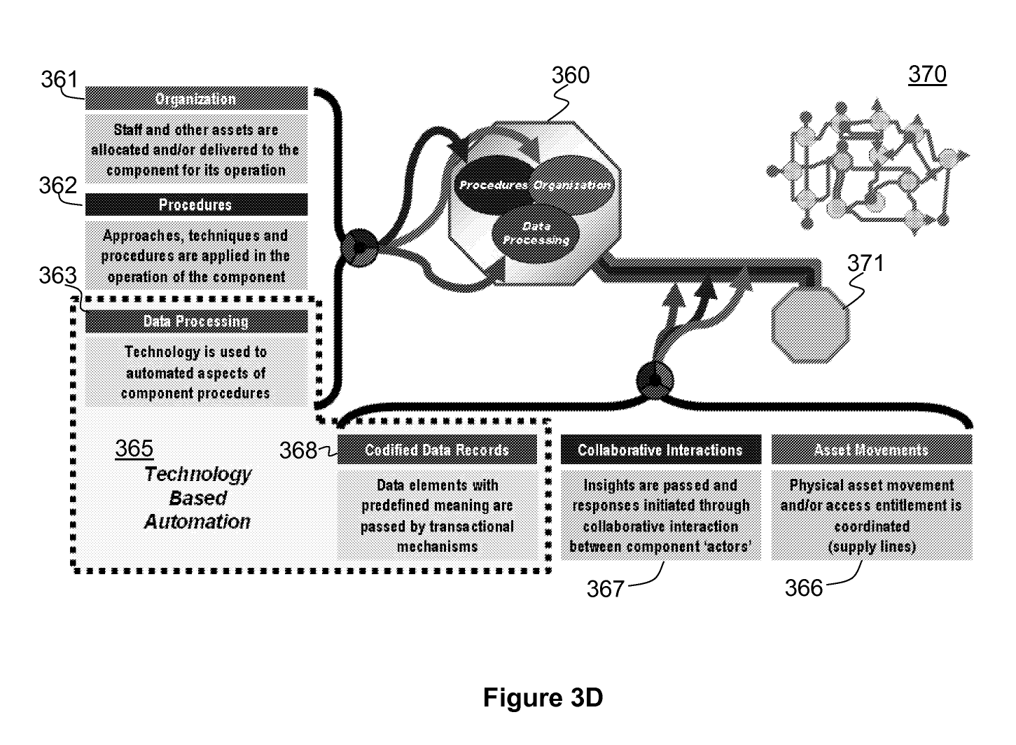

Turning now to FIG. 3 there is shown a prior art example of organizing principles that are able to be extended into more complex business environments by the design approach which is the basis for the present invention. The collaborative network 300 shown in FIG. 3A for the film industry shows in schematic form the various assets 310 (e.g. actors, writers, directors, producers) needed to produce a film, together with their collaborations 320 that are the constituent elements of the network.

As a people and project intensive industry, the business ‘building blocks’ of the film industry have been established in practice. Over time, the skill and capability specializations observed in the film industry have come to be accepted. Not only are they the subject of general agreement 331 across the industry, but there have developed expectations of performance of the various specialists that are the subject of shared perspectives and standards of measurement 332. Several further attributes of film industry collaboration should be noted because of their particular relevance to the business design approach which undergirds the present invention. It will be observed that the various specialists in the film industry are able to participate in multiple transactions independently 333. The organization of specialists in a particular film project is established for the life of the project 334, and in that sense the organizational principle of the industry is dynamic. For example, particular directors, actors, producers, studios and financiers may be involved together in one film project and with other corresponding functional specialists on other projects, sometimes at the same time. Particular identified assets may serve on a particular film project in multiple specialist roles, for example, as both actor and director or as both producer and financier. This movement of assets across functional borders 335 also applies to geographic borders, which is of particular interest in the global marketplace within which modern business enterprises operate.

Thus the film industry exemplifies certain key indicators 330 of industry segment transformation. The example presented by the film industry is not readily extended to more complex and larger scale business organizations, for reasons which are evident. The scale of a particular film project and the control structures necessary for effective collaboration of the partitioned specialties is small enough to be managed by personal chemistry and discussions carried on in person or by the now ubiquitous telephone and electronic mail, not requiring complex information systems support. To be workable and replicable across a wide range of far more complex business activities, the collaborative model of the film industry requires a series of novel extensions, including those of the present invention.

Yet the simplified film industry model is instructive for its coherence and stability, a coherence and stability often lacking in prior art approaches to business architecture, but present in the business design approach which forms the context of the present invention. The defined role of a participant in the film industry is similar in concept to a commercialization mechanism applied to a specific asset type. The dynamic collaboration that is apparent in the way the participants in the film industry work together is similar to the collaborations between components defined in a CBM map. The components implement the different commercialization mechanisms that manage the commercial assets of the enterprise, and the collaboration between components sets up a dynamic commercial equilibrium comparable to the observed stabilization of participant roles in the film industry. Whereas the coherence and stability of the film industry example have evolved over time, the coherence and stability provided by the business design approach forming the context of the present invention follows from the effort put into the distillation of an enterprise into non-overlapping asset based components. It turns out that the resulting CBM design structure for logical organization of the enterprise contains components that are reusable within and even across industries. Consequently, alignment of a commercial business and its supporting systems with a CBM model enables the aligned business to use solution approaches that have been developed in other businesses similarly aligned. A physical realization of a logical component might be easily integrated into many different organizations, facilitated by the fact that the role/boundary of the component is consistently interpreted across the different organizations.

Prior art approaches have understandably been developed to deal with business organizations as these organizations have structured themselves through practice. But whereas practice considerations led to asset based collaborative forms in the film industry, more complex commercial activities evolved in a different direction, focusing on core manufacturing facilities and the economies that come from volume production. Business control systems have, in consequence of this focus, followed a similar model. Transition to a different focus, embodied in the business design approach upon which the present invention is based, may therefore be viewed as a difference in emphasis, as will now be explained with reference to FIG. 3B. Business control 340 and production 342 are domains with different operating properties. The traditional manufacturing pipeline is most easily supported by process models 338, which have grown and dominated as described in connection with FIGS. 1A and 1B. The result has been business controls implemented as process structures.

The premise of the present invention is a reverse emphasis. The first step in reversing the emphasis is to align the business to a component business model (CBM) of the enterprise, as described in the above referenced foundation patent application. In a map 330 of components for an enterprise aligned in this manner, components are grouped under non-overlapping business competencies 332 (e.g. business and resource administration, new business development, customer management, etc.) and arranged by management level 334, that is, direct components (i.e. components that serve to define policy, plans, goals, organization and budgets, and assess overall performance of the business), control components (i.e. components involved with allocating tasks and resources, authorizing execution, applying policy, interpreting goals, and overseeing and troubleshooting performance), and execute components (i.e. components for administering, maintaining and operating the business).

In a CBM alignment, the components may be viewed as interacting via a service collaboration network 336. It should be noted that the CBM alignment may proceed incrementally, as described in connection with FIGS. 1C and 1D, using the additional novel structures and principles provided by the design approach upon which the present invention is based. The need for transition in the business control arena from a production focus, where process analysis 338 dominates, to a CBM alignment where collaborative service networks 336 dominate, may be understood by noting the different operating properties, as shown in FIG. 3B. With respect to supporting systems 344, business control 340 is characterized by workflow analysis and associated decision making, whereas production 342 is characterized by transaction processing. Message traffic 346 for business control 340 is conversational, whereas in the production domain 342 message traffic takes the form of structured data. In production 342 the nature of interactions 348 is structured and sequential, whereas in business control 340 the nature of interactions is less structured and less determinate, being asynchronous and in bursts across the network. When these differences are understood it becomes clear that business control requirements 340 cannot be adequately met by the process automation based designs characteristic of the production domain 342. On the other hand, the CBM design is consistent with a process design as well as a component based design. That is, the CBM design allows for the realization of a process design as a more constrained instance of a component based design, without the additional context provided by static designs 282 and without the organizing framework provided by the business schematic 286, and without the resulting conformity of business blueprints 292 to an organizing framework.

The advantages of a design approach that begins with alignment of the enterprise with a component business model and its corresponding service collaboration networks include better use of production functionalities in pursuit of improved business control. As shown in FIG. 3C, a CBM aligned model 350 enables the production functions 352 to be understood and provided with support structures for enhancing new business development 354, business direction 356, and business oversight 358. Effectively, this design approach provides the old process oriented production pipeline with collaborative handles better suited than process structures to serve the need for business controls to adapt to changes in the market place. Indeed, these collaborative handles and alignment to a component business model may facilitate a determination by the business whether a capital intensive ability to manufacture at the core of the supply chain is a competitive advantage, or whether the manufacturing capability can be undertaken as a specialty and integrated into the business via a collaborative network.

The full scope of a service center component design is shown schematically in FIG. 3D. Component 360 is supported by organization 361, procedures 362 and data processing 363. The organization 361 comprises staff and other assets allocated or delivered to the component for its operation. Procedures 362 comprise the approaches, techniques and procedures that are applied in the operation of the component. Data processing 363 refers to the technology used to automate aspects of component procedures. It should be noted that automation of the component's procedures refers to procedures internal to the component. The technology based automation 365 serving the component also includes codified data records 368, which are data elements with predefined meaning passed as output from and input to the component by transactional mechanisms.

Component 360 is part of service network 370, of which component 371 is an exemplar for the purpose of showing collaborative interaction 367 between component 360 and other components (e.g. 371) in the network 370. Insights are passed and responses initiated through collaborative interaction 367. In addition, asset movements 366 accounts for physical asset movement and the coordination of access entitlement to and from the component 360.

It is worth noting that this approach provides the context for making the decision as to what aspects of the business interaction between components are suited to machine/machine interaction, what aspects are better done with a user interface on one side of the interaction, and what aspects are best done outside the technology. The level of mechanization can often have a large impact on business behavior. Consider, for example, how the music industry changed when music became available as machine data over the Internet rather than on the physical media of a record or compact disc. To take just one component affected by such a change, assume a “Product Fulfillment” component had been responsible for tracking status of delivery of an order placed by a customer.

In the early days of the music business, for a small distributor, such a component might have been staffed 361 by one person keeping a simple log 362 of orders with columns for noting the date of the order, the date the order was delivered to shipping, and the date the order was shipped. The first log entry might have depended upon a communication 367 from a sales person identifying the customer and product, and the second log entry might have reflected a communication 367 to a shipping clerk, who would report 367 back when the shipment was mailed 366. It is possible that a single document—an order tracking form—might have been developed to serve as the vehicle for these communications and the source of information for the log, thus providing a better audit trail for the transaction.

Technology based automation 365 might then have been applied, first to automate 363 entries 362 in the log book by the allocated staff 361, and then to structure 368 the collaborative communications with the salesman and the shipping clerk. This might begin with automated assistance for generating and controlling order numbers on the sales side and tracking numbers on the shipping side, and evolve toward automating the order tracking form and either replacing the allocated staff 361 with a computer implemented agent, or perhaps using allocated staff 361 for a quality control function 362 over operation of the now automated procedures 362 for handling the log and the order tracking form.

If distribution of music media shifts from physical records and compact discs to Internet downloading, the salesman and the shipping clerk may be replaced (or supplemented during a transition period) by a web access interface, but the “Order Fulfillment” component might continue with its computer implemented agent, which would now collaborate 367 with the web access program (or a database serviced by the web access program) to collect order fulfillment information to be monitored for quality control purposes, which might be expanded by allocated staff 361 to include a variety of metrics associated with order fulfillment.

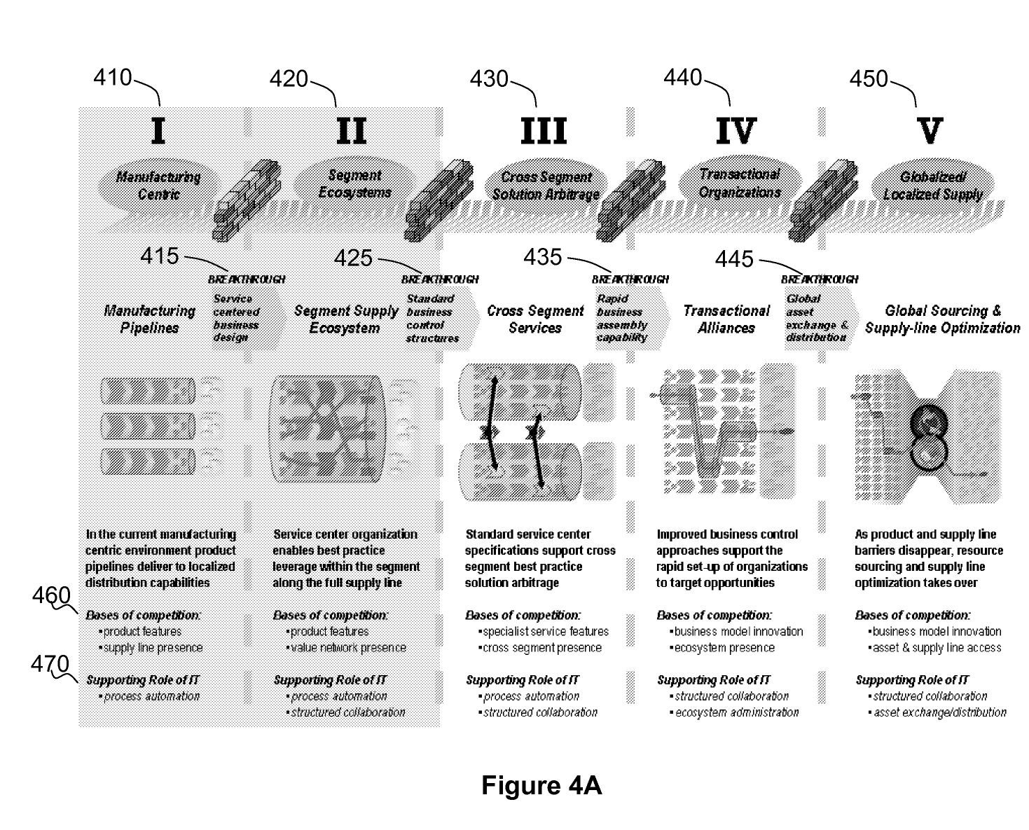

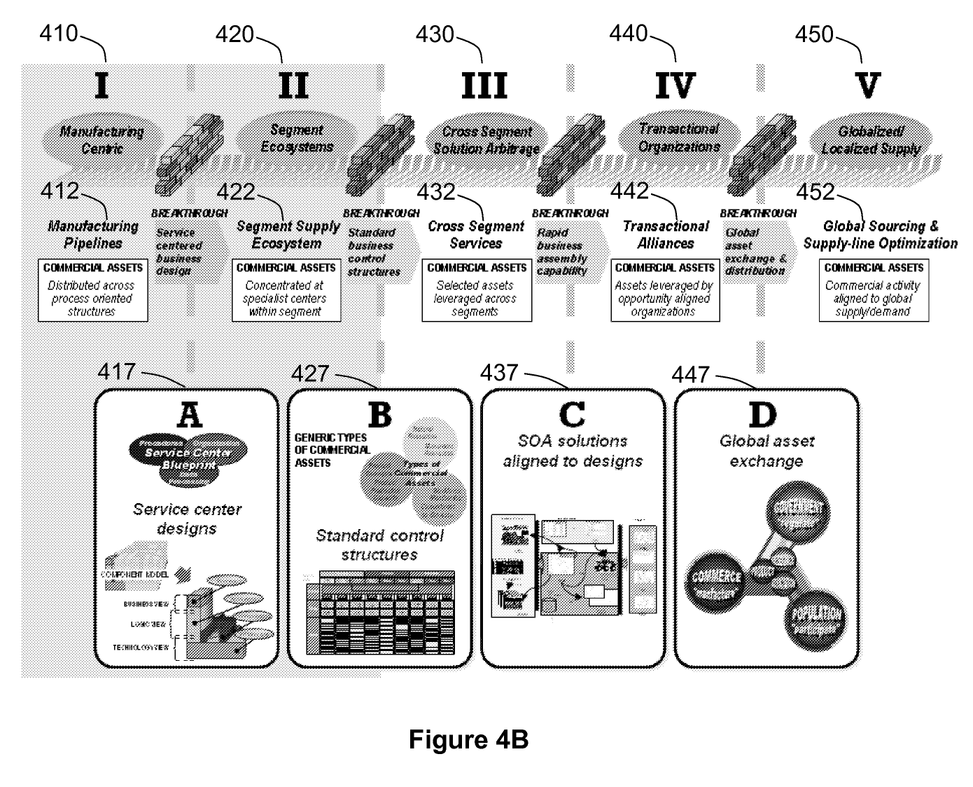

Thus the business design approach underlying the present invention provides flexibility in focusing attention on what the enterprise needs to do well to accomplish its mission. This flexibility holds promise for improvements in the commercial ecosystem as outlined in FIGS. 4A and 4B. In the current manufacturing centric environment 410 product pipelines deliver to localized distribution capabilities. The bases of competition 460 are product features and a supply line presence. The supporting role of information technology (IT) 470 is primarily process automation.

The asset based component business model (CBM) design approach redirects a process orientation to components whose assets are commercialized as services. The service centered business designs 415 that flow from this approach provide a basis for traditional manufacturing ‘monoliths’ to focus on their competitive strengths and divest themselves of functions in which they are less competitive than alternatives that are available through alliances. These alliances provide access to both commodity and best practice capabilities, based upon a certain commonality of components within an industry that facilitates in-sourcing and out-sourcing flexibility. Collaborative linkages between components remain operable whether linked components are in-sourced or out-sourced. This “plug and play” aspect is a consequence of the asset based design that is the premise of the present invention. The driver, enabled by componentization of assets, is to improve performance but without changing the ‘footprint’ of the business within its market or without changing the boundary of the market segment.

Initially, therefore, this is likely to result in a segment ecosystem 420, where a service center organization enables best practice leverage across manufacturing pipelines within the market segment and along the full supply line. The bases of competition 460 now include a value network presence as well as product features. IT's supporting role 470 expands from process automation to include structured collaboration within the segment's value network. As organizations both specialize in their areas of strength and divest of their non-competitive capabilities this leverage is likely to be contained initially within established market segments. But in time this market segmentation will be eroded as ways are found to support common requirements across segment boundaries through use of standard business control structures 425. Commercial asset types and control mechanisms are similar if not the same regardless of industry, so it is inevitable that as specialists focus on providing services associated with selected components they will discover that they can offer their services beyond the established industry relationships.

The development of solution arbitrage across market segments 430 reflects standard service center specifications, enabling best practices in one segment to be used effectively in another segment. The bases of competition 460 include a cross segment presence and service features provided by specialists. Generic service centers are developed by organizations that offer commercial services that can be configured for many different market segments. These service centered offerings will cross pollinate approaches across segments leveraging or ‘arbitraging’ best practices and scarce resources. This practice erodes the product, geopolitical and organizational scale boundaries that have traditionally defined market segments. Some examples of specialized cross market segment capabilities already exist such as market research, customer behavior modeling, consumer credit rating and many more utility type business functions in staff and facilities administration and finance.

In most industries today cross segment capabilities represent the exception with the significant majority of business activity being tuned to the nature of the underlying product. An implication of the componentization of business and the disassembly of the production line is that such product specific features become more narrowly concentrated within the core manufacturing area and more generic capabilities can be used to support the significant remainder of business activity, first within the ecosystem segment 420 and then across segments 430.

Operational improvements in the ability to leverage best practice service centers across segments can be expected to support a rapid business assembly capability 435, resulting in more dynamic alliances and the development of transactional organizations 440. As the coverage of more general business service centers expands, service standards, operational approaches and system solutions will streamline the process of establishing inter-organizational links. Improved business control approaches will support the rapid setup of organizations to target opportunities. This will support highly dynamic commercial alliances that might exist for the duration of a single major transaction or market opportunity. In this environment the bases of competition 460 include a presence in the broader ecosystem and the development of innovative business models for leveraging dispersed assets to meet market place targets of opportunity. The supporting role of IT 470 includes the administration of this ecosystem.

As commerce acquires the operational stealth to assemble ‘transactional alliances’ 440, the key determinants of success become access to critical manufacturing assets such as raw materials and intellectual property and the subsequent ability to deliver both virtual and physical product through appropriately configured supply channels. This developed ability to engineer the exchange and distribution of assets on a global basis 445 is the foundation of an ecosystem 450 focused on global sourcing and supply-line optimization for a localized supply. Access and distribution of commercial assets is managed globally. The bases of competition now include access to these assets and supply-lines. The supporting role of IT 470 includes the exchange and distribution of these assets.

As service organizations develop more and more capabilities that can be offered and deployed across multiple segments the possible reach of the business ecosystem grows. This expansion will cross not only product boundaries but also geopolitical borders, in a globalization process that is well documented. It is less obvious how the same factors that are removing the manufacturing pipeline constraints noted above are making it increasingly easy for small and mid size firms to play alongside the large multi-national players. The removal of product, geopolitical and organizational scale boundaries that is expanding the market ecosystem is counterbalanced by factors that constrain the practical growth of any one organization within the ecosystem. These include the need to focus on narrow areas of specialization to be competitive and the need to adjust to limitations in the number and complexity of connections that can be managed effectively. While the improvements provided by the present invention enable business designs with supporting IT able to manage a connection complexity well beyond that of the film industry described using FIG. 3A, there remain limitations and further opportunities.

Once business has embraced the specialized service model and started to align to a component business model, subsequent barriers to change can fall more easily. This is because subsequent steps do not require the resolution of complex technical problems but are driven more by considerations such as organizational re-structuring and market adoption that can as much trigger as impede change.

To summarize the factors driving the changes reflected in FIG. 4A include:

business and market componentization—the progressive migration to organizational structures that are an assembly of specialized and optimized business ‘building blocks’;

cross segment solutions—the evolution of service organizations offering building block solutions that can be configured to support multiple market segments; and

support for more dynamic alliances—improvements in operational and technology approaches that support the more dynamic and responsive assembly and dissolution of organizational alliances within the growing market ecosystem

The evolution of commerce through the five stages shown in FIG. 4A does not need to follow in strict sequence nor does every aspect of any one organization need to evolve in concert. In practice most organizations will evolve selected parts of their business at different rates along the continuum and will also probably hold on to elements that might be better supported through external sourcing due to organizational inertia or their limited capacity to handle change.

As long as the transformation remains between established players in a segment it's a fair race. As the markets and available solutions mature towards later stages however, opportunities open up for new entrants to enter the fray. These will have the distinct advantage of not carrying the legacy inertia in their systems and workforce as they organize to meet market demand.

FIG. 4A highlights the current focus on generally anticipated changes brought about by componentization—from Stage I 410 to Stage II 420—and also suggests other more radical changes that might follow—Stage III 430, Stage IV 440 and Stage V 450.

FIG. 4B adds certain elements to the display presented in FIG. 4A, describing how commercial assets are handled at each stage and identifying facets of asset based design enabling transition from one stage to the next. In the manufacturing centric stage 410, characterized by manufacturing pipelines 412, the assets of the enterprise are distributed across process oriented structures. Transition design feature 417 is service centered business designs 415, exemplified by linkage to service oriented architecture (SOA) solutions. These designs define a logical business partition based on a specialization for which organizational, procedural and IT supporting requirements can be determined along with a specification of the boundary and external business messages interface.

In the stage 420, characterized by the formation of ecosystems aligned to respective market segments, commercial assets 422 are concentrated at specialist centers within a segment. The design feature 427, which enables transition to the stage 430 that leverages solutions across segments, is the standard control structure. As general asset types and commercialization mechanisms are defined, a standard collection of generic control structures can be specified. These generic control structures can be deployed across industries.

This aspect of control structures has implications for the nature of solutions that are developed conforming to an asset based design approach. For the specification of the control mechanisms the asset based design approach distinguishes between the purpose or role, which does not vary particularly, and its particular implementation that does evolve as new practices are discovered or invented. Asset types are not specific to any one industry. Items such as staff, buildings, equipment, knowledge, customer relationships occur in many if not all industries. Similarly and consequentially, the commercialization mechanisms associated with the use of a generic asset type are themselves fairly generic. For example, for the asset type customer relationship, the associated commercialization mechanism ‘account for payments/receipts’ is a general requirement.

Industry specific requirements (and other reasons for specialization such as geopolitical, scale or sophistication) are related to specific features of the implementation of the commercialization mechanism rather than its purpose or role. Since purpose or role of an asset type is generic, it therefore follows that the control structures and their generic implementation features are transferable between industries. In addition, of course, it is possible that even the non-generic implementation features developed in one industry may be harvested for redeployment in other industries as a new differentiating feature. This would be an added benefit, but seeking these benefits should not obscure the basic reusability across industries of the generic implementation features of control structures aligned to the purpose or role of an asset type.

In the cross segment services stage 430 selected assets 432 are leveraged across industry segments. The transition to organizations built around particular transactions 440 is facilitated by consistently aligning 437 service oriented architecture solutions to asset based business designs. The feasibility of this approach has been demonstrated for a meaningful sample of business component designs, and over time this will support the rapid assembly and disassembly of alliances in the commercial ecosystem 435. In these transactional alliances commercial assets 442 are leveraged by being able to be applied to a transaction through an opportunity aligned organization. Finally, as support for the transactional organization 440 is established, the primary basis for competition becomes access to, and effective distribution of, critical commercial assets. This competitive environment can be expected to generate global asset exchange mechanisms 447, which transition to a global sourcing and supply-line optimization regime 452 where commercial activity is aligned to global supply and demand.

The role of information technology, in the above described developments toward componentization of the business enterprise, is challenging. The most straightforward application of information technology is automated support for repeatable production processes, as described for the manufacturing centric stage 410. This appears to suggest that large size and economies of scale are likely attributes of an enterprise optimally supported by IT. However, a contrary conclusion is suggested by evidence of the use of asset based designs in stages II, III and IV. This evidence, accumulated in the financial services industry, suggests that small and mid sized businesses are less constrained by their computer systems than the larger firms. The causes have been traced to the much smaller system portfolios and the corresponding reduction in the number of business connections needed to manage the business. It can be shown that as a business grows linearly the number of business connections grows to the power of two.

Thus the early experience with service centered operational design has revealed two implications for the future direction of asset based business designs that appear to address the problem of scale complexity, at least in part:
Specialization reduces the number of necessary business connections.

As organizations focus on those areas of competitive strength and divest of other areas, though their capacity to handle business volume can increase, the range of activities they need to coordinate is reduced.
Interactions are simplified.

An interesting and less obvious effect of operational specialization is that the ‘traffic’ making up the business connections is simplified. In a traditional process model all parties involved in any stage of execution need to have expertise relating to whatever the kind of item the process operates on (for example, the set-up, maintenance and eventual closing out of customer agreements). Much of the traffic between stages involves passing transactional detail between parties as they coordinate to process items. In the specialist service center model, this expertise is encapsulated in each single center that is responsible for its type of item for the full life-cycle (e.g. a full life-cycle customer agreement specialist). The traffic between service centers contains less transactional data being more about operational coordination between specialists.

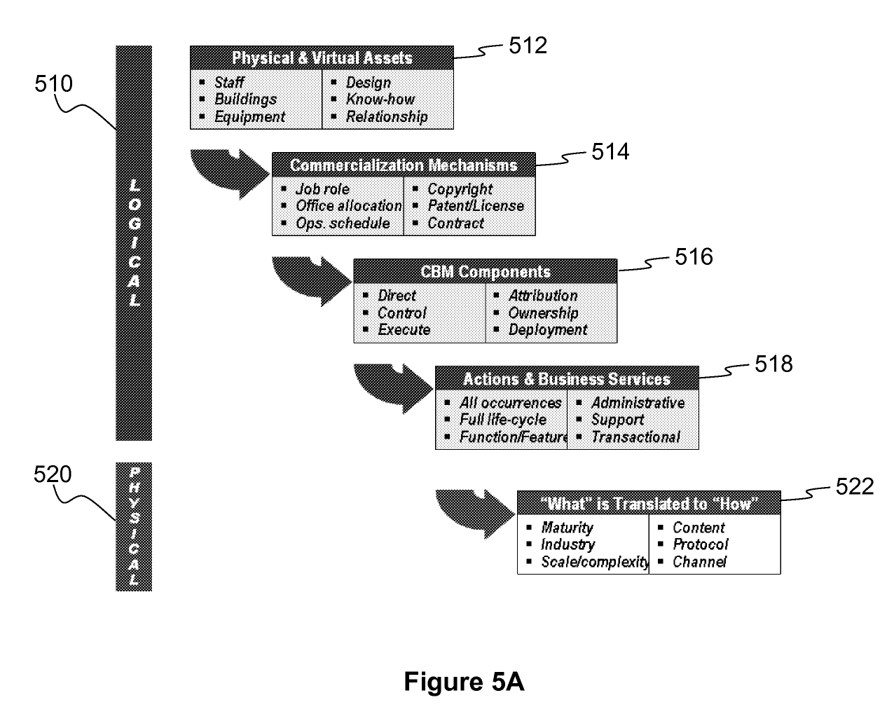

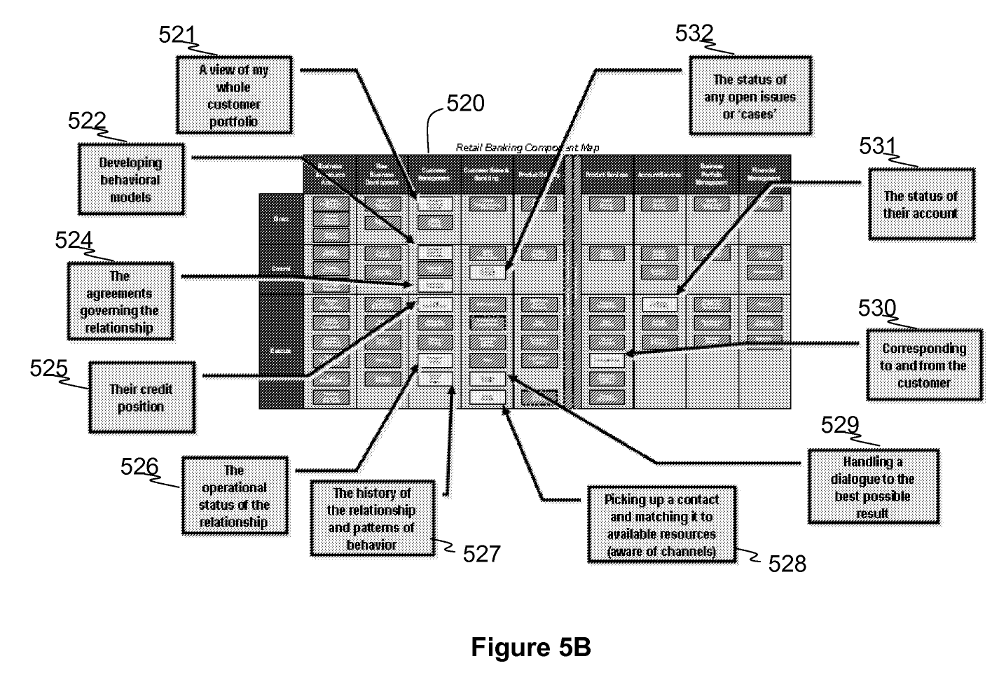

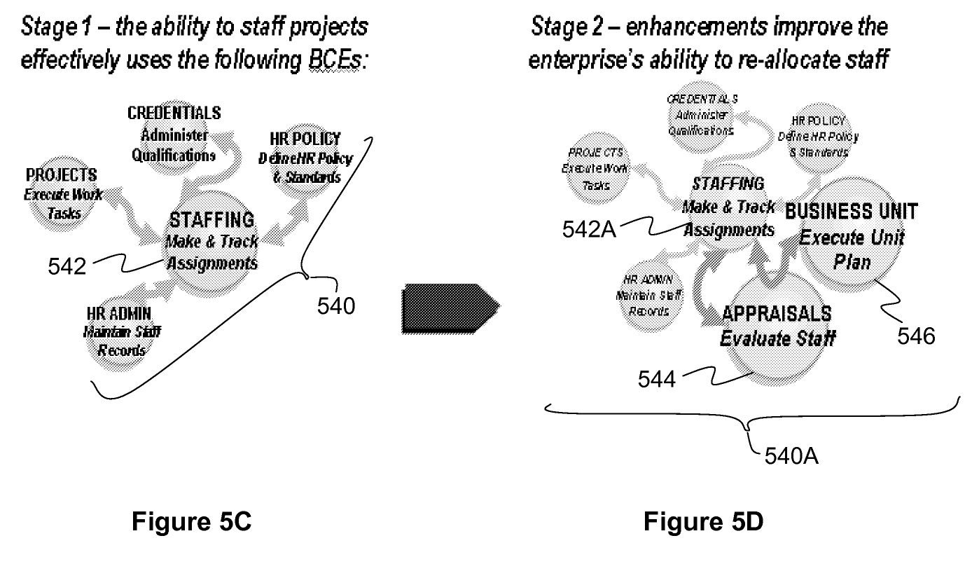

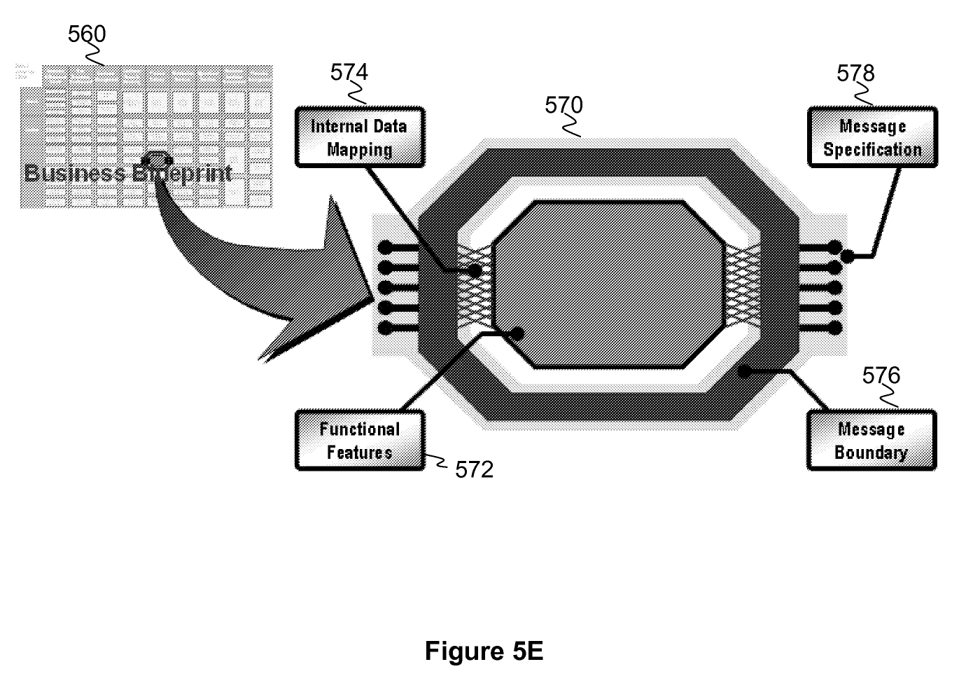

The design approach of a business architecture using an asset oriented design is shown schematically in FIG. 5A. The logical decomposition hierarchy 510 includes a number of elements. Physical and virtual assets 512 are identified at the top of the hierarchy. These assets include staff, buildings, and equipment, as well as the virtual assets of designs, know-how, and relationships. These assets are made valuable by commercialization mechanisms 514. Examples include a job role (for staff), an office allocation (for a building), and an operations schedule (for equipment). Copyrights, patents, intellectual property licenses, and contracts are examples of commercialization mechanisms for virtual assets.

Next in the hierarchy are the components themselves 516, each of which is a locus of identified assets and commercialization mechanisms. Components are more fully described above and in the foundation patent application. The actions and business services 518 performed by the components 516 form another stage in the decomposition. This level 518 of the design approach covers the functional features of each service provided by the component, the instances and life cycle of the service, as well as administrative, support and transactional aspects. Finally, at the physical level 520, an implementation design 522 translates component activities so as to identify the channels, protocols and content associated with the services, together with notations regarding the industry involved, the maturity of service solution provided, and its scale and complexity.

FIG. 5B highlights control mechanisms in one exemplar service network of components organized in CBM map 520. The control mechanisms in this customer resource management service network highlight examples of common control mechanisms applied to leverage a particular commercial resource type, namely, the resource type “customer relationship”. This is an intangible but very important business asset. The control mechanisms for commercializing this asset are: a view of the customer portfolio 521, behavior models 522 that are being developed, agreements governing the relationship 524, customer credit positions 525, the operational status of the relationship 526, the history of the relationship and patterns of behavior 527, a channel awareness function 528 for picking up a contact and matching it to available resources, a function for handling a dialogue to the best possible result 529, corresponding with the customer 530, the status of the account 531, and the status of any open issues of ‘cases’ 532.

It should be emphasized that the functionality of the asset based component design approach underlying the present invention depends upon a realistic and objective view of business assets. This view typically identifies assets that may be denominated “intangible” as well as “tangible” in conventional parlance, but these distinctions are misleading because component structures are a representational convention ultimately derived from and connected to the physical structures of the business: its people and its other material resources, its products and services in the marketplace, and its customers. In order to usefully and effectively describe the activities which need to be undertaken by the business it is essential to identify within the component structure asset views—such as the “intangible” asset of “customer relationship”—that best facilitate the development of control structures that commercialize the asset.

This service network will be arranged to show the operational connections between the components, in the manner described for a simpler network 540 shown in FIG. 5C. The network structure and the flexible collaborative mechanisms employed by components in the network simplify enhancements of the network, as shown in FIG. 5D. Service network 540 provides the ability to staff projects effectively, using four business control elements (i.e. PROJECTS for the execution of work tasks, CREDENTIALS for the administration of qualifications, HR POLICY for defining HR Policy and standards, HR ADMIN for maintaining staff records) each collaborating with a STAFFING element 542 for making and tracking assignments. To improve the enterprise's ability to re-allocate staff an APPRAISALS business control element 544 and a BUSINESS UNIT element 546 for executing a unit plan are added, with collaborative links to STAFFING element 542A, as shown in FIG. 5D. The resulting service network 540A provides an enhanced staffing service to the enterprise.

The flexible enhancement example illustrated in FIGS. 5C and 5D is enabled by components whose collaborative abilities are disciplined in accordance with the structure shown in FIG. 5E. Components are defined in a non-overlapping and comprehensive manner as described above and in the foundation patent application for the asset based component business model, and arranged on a CBM map 560. Each component added to a service network—which may be done incrementally, e.g. component 134 shown in FIG. 1C—is provisioned for collaborative support as shown in FIG. 5E. Component 570 is characterized by functional features 572. Internal data mapping 574 and message specification 578 needed to support the commercialization mechanisms and control structures of the component 570 are connected through message boundary 576. Internal data mapping 574 is a “standards” based mapping of information using meta data to link to legacy data structures. Message specification 578 provides definition of the business services provided by the component, along with an hierarchical decomposition to the underlying services provided through the technology layer supporting the enterprise. A structured breakdown of prevailing practices functionality (for legacy system alignment) is described by functional features 572. Message boundary 576 provides a buffer that effectively wraps a service envelope around component 570, including interim capabilities designed to mask limitations reflecting staged development of the component 570. The design encapsulates specific business expertise within the component, leading to service specifications that are optimized and re-usable.

It should be emphasized that these structural disciplines, including the commercialization mechanisms and control structures, are an important and enabling aspect of the asset based model and design principles upon which the present invention is based. These disciplines are in contrast to the film industry example described above in connection with FIG. 3, where the elemental building blocks of assets correspond closely to the job specializations of people working in the industry, and where the nature and complexity of the interactions between these people tend to be well defined and involve the transfer of limited amounts of information that can be handled adequately by conventional support technologies such as the telephone and electronic mail. In order to enable effective collaboration in a generic business service network specific systems approaches are needed. In general, the elemental building blocks (i.e. components) for a medium or large scale business do not neatly align with a consistently defined role that can be supported simply by engaging an individual.

To enable a definition of business architectural design that supports the development of standard solutions that can be adopted incrementally it is also necessary to apply a design discipline to the definition of the logical blueprint. It is a well understood property of a classification decomposition of some subject area that there is a point in the progressive decomposition where the distinction between peer level partitions degrades from having discrete non-overlapping definitions, to becoming utility and repeating in nature, i.e. the classification degenerates from single to multiple relationships in the hierarchy.

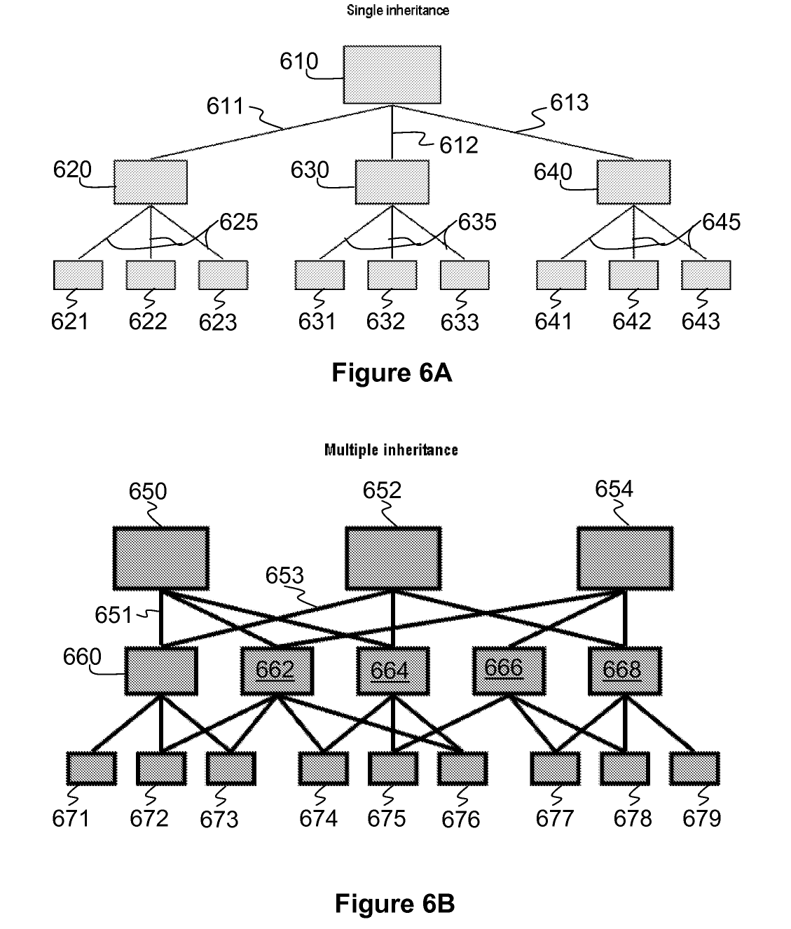

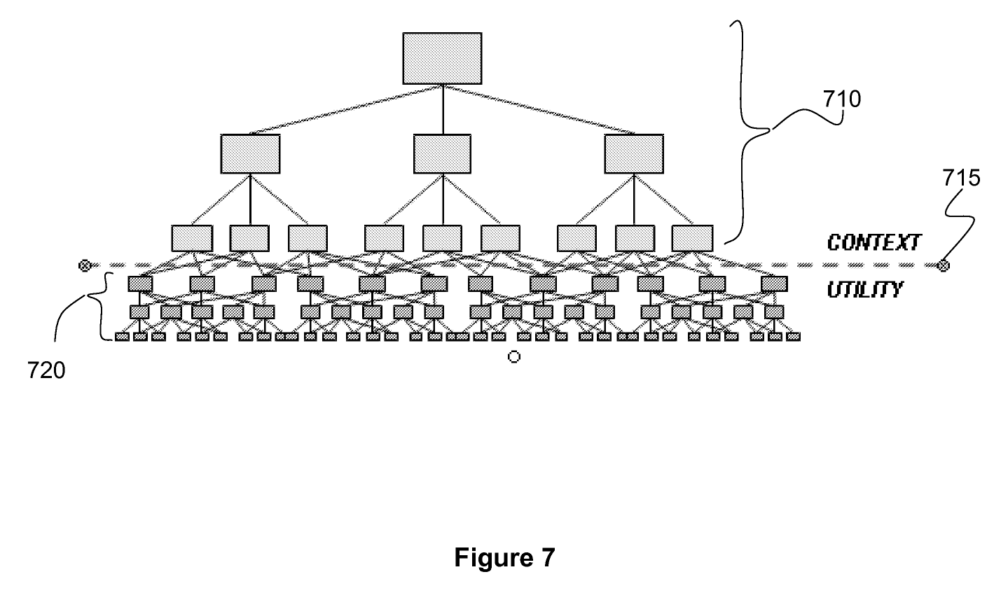

This may be understood conceptually by reference to FIGS. 6A and 6B, and FIG. 7. FIG. 6A describes a single inheritance decomposition hierarchy. Each node at a level (e.g. 620, 630 and 640) is connected to only one node at the next higher level (e.g. 610, through connections 611, 612 and 613, respectively). Similarly, each node at the next lower level (e.g. 621, 622, and 623) is connected 625 to one and only one node 620. The other nodes follow the same pattern: each of <631,632,633> is connected 635 to only one node 630; each of <641,642,643> is connected 645 to only one node 640.

In contrast FIG. 6B describes a decomposition hierarchy characterized by multiple inheritance. For example, node 660 is connected 651 to next higher level node 650, but is also connected 653 to node 652. Similarly node 662 is connected to nodes <650,654>, node 664 is connected to nodes <650,652>, and node 668 is connected to nodes <652,654>. While node 666 is only connected to node 654, it is not possible to separate out node 666 because node 654 is part of the multiple inheritance structures of nodes 662 and 668. Similar multiple inheritance structures apply to the nodes at the next level down: <672:660,662>, <673:660,662>, <674:662,664>, <675:664,666>, <676:662,664>, <677:666,668>, and <678:666,668>. As above, there are single linkages <671:660> and <679:668>, but these cannot be separated out because the higher level nodes are part of other multiple inheritance structures.

In the typical decomposition of a business a single inheritance structure eventually devolves into a multiple inheritance structure. This is shown in FIG. 7, where single inheritance structure 710 devolves into multiple inheritance structure 720, with boundary 715 separating the two. Above boundary 715 the decomposition proceeded by single inheritance, the various levels therein providing context for the entity being decomposed. Below boundary 715 the decomposition identified items having a utility to more than one node above. Consequently, for the purposes of the present invention, boundary 715 defines a threshold of decomposition.

An example of this threshold of decomposition in building architecture would be where a building, with a defined purpose, is first decomposed into its floors, each of which maintains a discrete purpose, and then further to the types of rooms. At this level it is still possible to consider each type of room as being discrete. Further decomposition of the room might result in the identification of items such as doors, walls, windows, furnishings and immediately it is apparent that these items can sensibly occur in many different types of room—i.e. they may now be linked through multiple inheritance classification.

An observed property of the lowest level decomposition item of building architecture is that the items remain mutually exclusive of each other, and if the decomposition is comprehensive, they collectively define the full set of possible design elements. In building architecture the types of room can be used as an organizing framework to group unique properties of room designs in a manner that allows us to select and assemble and these elemental design structures in any appropriate combination to create a building blueprint as determined by the associated dynamic properties we wish to support.

It is the premise of the present invention that these principles can be adapted to business architecture and to the decomposition analysis that is necessary to apply an architectural principle. In particular, the objective of the present invention is to identify the lowest level of decomposition of a business where the items at that level a) remain mutually exclusive of each other, and b) collectively define the full set of possible design elements. That is, to use a shorthand term, the design elements at the selected level are MECE, or “Mutually Exclusive and Collectively Exhaustive.” This level is identified by the term “threshold of decomposition” as described above, and design elements at this level are termed “elemental design elements”.

The corresponding commercial control structures are, therefore, also termed “elemental.” By lexicographic convention in this patent application, the terms “elemental design element” and “elemental control structure” are narrowly limited to the foregoing meanings. By implementing the above described asset based design approach at the threshold of decomposition, where the components in the component business model are elemental design elements and the assets of a component are commercialized by corresponding elemental control structures, it is discovered that these components and their commercializing control structures are highly re-usable within and across market segments and can be applied incrementally within an enterprise to migrate the enterprise toward an asset based model that provides improved stability and resilience for the enterprise as the enterprise responds to changing market conditions.

The purpose of this invention is to apply the concept of a threshold of decomposition to the logical designs of business architecture in order to expose the elemental structures of commerce. The design technique upon which the present invention is based identifies commercial asset types and through commercialization mechanisms defines a business use or purpose of that asset type—for example an employee, assigned to a project, or a building assigned for use as the Head office.

By applying a structured decomposition of the commercial assets and their uses down to the threshold of decomposition where the elemental items of design are exposed, a collection of mutually independent business control elements can be defined, that as with types of room, can be associated with different business design blueprints. Just as the elemental design of a type of room, such as a kitchen (and indeed aspects of its physical realization) can be redeployed in different buildings, so can aspects of business control systems be re-used in the equivalent deployment of business architecture.

A test of this principle of business architecture is its practical application to the incremental adoption of these elemental structures of commerce. Experience with service based businesses demonstrates that when business control systems are developed as a solution to a current need for change, aligning the solution to the architecture defined by these elemental structures provides a persistent and reusable structure that can be adopted incrementally alongside the existing business systems that might be in place in an established commercial business. It should be emphasized that a given “increment” in this process—because it is typically directed toward a solution that requires participation of several asset types of the business—will comprise a collaborative network of elemental design elements, not unlike the collaborative network of participants in the above described example from the film industry. This conception of a collaborative network (or “collaborative service network” or “service network”) also covers the limiting case where only a single elemental design element constitutes an “increment” in migration toward an asset based business architecture.

It should also be emphasized that a collaborative network—in contrast to the simple film industry example—cannot effectively “collaborate” without automated support for the collection of rules and guidelines that define operability of the collaboration. Automated support—including both physical hardware, software representations of corresponding business realities associated with both tangible and intangible assets of the business defined by elemental design elements, the transformations of these software representations, and the data transformations that implement collaboration—is itself more stable because it is aligned to these persistent elemental design elements.

Furthermore, the incremental adoption process is finite and manageable because there are a limited number of asset types and commercial control structures. New problems and challenges are a constant feature of survival in commerce, but a given business entity (i.e. a business enterprise, an industry, or a value chain) will have a finite number of components in its CBM map. By crafting solutions to successive new problems and challenges so as to align these solutions to elemental design elements, migration to a full but finite complement of components will be accomplished. It should be noted that this finite complement of CBM components is in contrast to a potentially infinite, and practically never ending, nest of interconnected computer supported processes that characterize the prior art process oriented approach to business architecture.

The reasoning for this is that a solution built conforming to the above described asset-based design supports a persistent need by being aligned to the static ingredients of business and their successful leverage. More conventional commercial systems design has focused on automated support for repeating behaviors or dynamic aspects of business, as noted above with respect to FIG. 2B. Business behaviors will and do change, often rendering conventional systems built to support their execution obsolete. But the role that static ingredients play in these changing dynamic behaviors is less volatile.

At the above described level of decomposition, at the border line between “context” and “utility” as described in connection with FIG. 7, the single-inheritance “role” of a business component may be confirmed by application of checklists such as the following: a) the role is repeated in multiple industries; b) the role is part of a generic “periodic table” of business components; c) the business component having the role can be thought of as an operational service center; d) the role is unique, supporting some specific aspect of business activity; e) the business component having the role can be described in terms of its procedures, organization and information technology; f) the business component having the role operates by collaborating with other components using “business services” to get things done; g) the business component having the role is a design blueprint, able to be deployed in different ways (e.g. single centralized or in multiple locations); h) the business component having the role has performance targets that can be defined and measured; and i) its role typically doesn't change, but the way it does its job can continually evolve.

Consider a changing behavior such as how a business might roll out a new product design. This process could easily change as new design techniques, business rules or priorities cause the business to refine its approach. But the capability of a business to assign its employees to executing this or any other task is a need that is less likely to change. A business solution that provides the necessary control of assigning asset type “employee” to a task (in this case executing the current version of the product rollout) is a persistent requirement as long as there is work to do and employees to assign. It is also the case that such a solution can be introduced into the business systems of an existing commercial operation and adopted alongside existing solutions.

Not only can the initial implementation of a solution aligned to a persistent need (such as the ability to assign staff to projects) be engineered into existing activities for selective adoption but the solution, by charting out a unique element or ingredient of business activity, defines a requirement that can be refined and enhanced over time. In building architecture, the elemental static design of a kitchen can be uniquely isolated and adopted as necessary into any building requiring such an accommodation. Over time the features that might be associated with the realization of a kitchen have evolved as new technologies have been factored into the concept. In the same way it is likely the same static element of business architecture will evolve new ways of execution—in the assignment example, enhanced analysis of needs and performance might be used to improve the assignment decision, for example.

Consider the case when a building is broken down into its composite ingredients. The building with its intended use—for example a hotel and conference center—might have different purpose designed floors each of which has many different types of specialized rooms. So far the decomposition can be made to follow the rules of single inheritance. But as the different types of rooms are decomposed into their constituent parts: windows, doors, floor, walls, ceiling, furnishings etc. These items are no longer necessarily unique to any particular type of room—they are utility designs that can recur in many different types of rooms and now would be correctly referenced by multiple inheritance.

Similarly for the asset based business architecture which is the basis for the present invention, a business component—comprised of an asset type and a mechanism for commercializing that asset—follows the rule of single inheritance. But if a business component—what we have called an “elemental design element”—is further decomposed, so as to expose constituent elements needed for carrying out the role of the component, these further constituent elements may recur in other business components. For example, a currency conversion function that might be used in the implementation of a financial control component adapted to a company's international lines of business could also be found in a sales component that reports revenue. Another example would be a mechanism for gathering information about the skills and experience of an employee, which may be usable in an employee assignment component but also usable in a component charged with responsibility for making statistical reports to the government. Yet another way of focusing on the essential aspects of an “elemental design element” is by analogy to the “role” of a director in the film industry example described in connection with FIG. 3A. While a director might also make coffee for the film team, especially in a small film project, others could also make coffee. Making coffee is therefore subject to multiple-inheritance rules, and the “role” of a director does not include making coffee. Similarly, the “role” which characterizes an “elemental design element” is defined in the present invention so as not to include potential “roles” that can be performed by other components. Thus it will be understood that the threshold level of decomposition identified by the present invention is consistent with the MECE concept described above.

While the role of a component is likely to remain constant—and therefore provide a stable building block for “on demand” assembly of service networks adapted to respond to particular market changes or competitive circumstances—specific attributes or functions needed to configure the component to operate within a particular service network may well we usable by different components. Thus, such attributes or functions have a multiple-inheritance aspect and therefore cannot themselves be the basis for an “elemental design element” or business component.

While the invention has been described in terms of preferred embodiments, those skilled in the art will recognize that the invention can be practiced with modification within the spirit and scope of the appended claims.

Having thus described my invention, what I claim as new and desire to secure by Letters Patent is as follows:

1. A method of developing an architecture for a business, comprising:
decomposing an asset based model of the business to a threshold level, the asset based model being comprised of business components, each business component being defined by an asset type of the business and a mechanism for commercializing said asset type to produce a value for the business, where each decomposed asset type and corresponding commercialization mechanism at the threshold level and levels above the threshold level has one and only one parent, and at least two decomposed assets and corresponding commercialization mechanisms at the threshold level have at least one child in common;
associating each asset type and corresponding commercialization mechanism at the threshold of decomposition with an elemental design element from a component business model (CBM) map of an industry within which the business competes.

2. The method of claim 1, wherein said decomposing is accomplished in a series of steps over time, each incremental decomposition being directed to assets and commercialization mechanisms associated with adapting the business to a particular change in a market within which the business competes.

3. The method of claim 2, further comprising, for each step in said series:
decomposing the assets associated with adapting the business to the particular market change to distinct and non-overlapping asset types; and
associating each said asset type with a distinct commercialization mechanism, the commercialization mechanism operating on the asset type to produce a result that contributes to adapting the business to said particular market change.

4. The method of claim 3, further comprising, for each step in said series:
confirming from said industry CBM map that each asset type and associated commercialization mechanism corresponds to an elemental design element on said industry CBM map.

5. The method of claim 4, further comprising, for each step in said series:
providing each elemental design element with information systems support for operation of the commercialization mechanism.

6. The method of claim 5, further comprising, for each step in said series:
configuring the adaptation to said particular market change as a collaborative network among the elemental design elements.

7. The method of claim 6, wherein each collaborative network is implemented through services provided and received among the elemental design elements.

8. The method of claim 7, wherein operation of each collaborative network includes movement of assets between elemental design elements.

9. The method of claim 6, wherein the information systems support for at least one elemental design element is configured from a template provided on said industry CBM map.

10. The method of claim 6, wherein the information systems support for at least one of the collaborative networks replaces a legacy information system with information systems aligned to respective elemental design elements and combined through the collaborative network.

11. The method of claim 6, wherein the step of configuring is supported by a computer system providing a display of the industry CBM map with a capability of selecting business components from the industry CBM map and creating a CBM map of the selected components adapted to the business.

12. A system for developing an architecture for a business, comprising:
means for incrementally decomposing an asset based model of the business to a threshold level, the incremental decomposition being directed to assets and corresponding commercialization mechanisms associated with adapting the business to a particular market change, there being one or more elemental design elements encompassing the assets and corresponding commercialization mechanisms, each elemental design element having a stable and persistent commercial role and being defined by an asset type of the business and an elemental control structure for commercializing the asset type to produce a value for the business;
means for associating each elemental design element at the threshold of decomposition with a corresponding elemental design element from a component business model (CBM) map of an industry within which the business competes.

13. The system of claim 12, wherein each decomposed asset type and corresponding elemental control structure at the threshold level and levels above the threshold level has one and only one parent, and at least two decomposed assets and corresponding elemental control structure at the threshold level have at least one child in common.

14. The system of claim 12, further comprising:
means for providing each elemental design element with information systems support for operation of the elemental control structure.

15. The system of claim 14, further comprising:
means for adapting to said particular market change by configuring the elemental design elements and their respective supporting information systems as a collaborative network.

16. The system of claim 15, wherein the information systems support for at least one elemental design element is configured from a template provided on said industry CBM map.

17. The system of claim 15, wherein the information systems supporting the respective elemental design elements, by combination in the collaborative network, displace a legacy information system.

18. A computer implemented system for developing an architecture for a business, comprising:
first computer code for incrementally decomposing an asset based model of the business to a threshold level, the incremental decomposition being directed to assets and corresponding commercialization mechanisms associated with adapting the business to a particular market change, the threshold level defining one or more elemental design elements encompassing the assets and corresponding commercialization mechanisms, each incremental design element being defined by an asset type of the business and an elemental control structure for commercializing the asset type to produce a value for the business;
second computer code for associating each elemental design element at the threshold of decomposition with a corresponding elemental design element from a component business model (CBM) map of an industry within which the business competes,
wherein each decomposed asset type and corresponding elemental control structure at the threshold level and levels above the threshold level has one and only one parent, and at least two decomposed assets and corresponding elemental control structure at the threshold level have at least one child in common.

19. The computer implemented system of claim 18, further comprising:
third computer code for providing each elemental design element with information systems support for operation of the elemental control structure; and
fourth computer code for adapting to said particular market change by configuring the elemental design elements and their respective supporting information systems as a collaborative network.

20. The computer implemented system of claim 19,
wherein the information systems support for at least one elemental design element is configured from a template provided on said industry CBM map, and
wherein the information systems supporting the respective elemental design elements, by combination in the collaborative network, displace a legacy information system.
